(19) United States
(12) Patent Application Publication
(10) Pub. No.: US 2007/0135497 A1
(43) Pub. Date: Jun. 14, 2007

(54) Biphenyl derivative or its salt, and pesticide containing it as an active ingredient

(75) Inventors: Shigeru Mitani, Shiga (JP); Hitoshi Nakayama, Shiga (JP); Koji Sugimoto, Shiga (JP); Munekazu Ogawa, Shiga (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ISHIHARA SANGYO KAISHA LTD., Osaka-shi, Osaka (JP)

(21) Appl. No.: 10/578,778

(22) PCT Filed: Nov. 10, 2004
(86) PCT No.: PCT/JP04/17034

§ 371 Date: May 9, 2006

(30) Foreign Application Priority Data
Nov. 11, 2003 (JP) 2003-381152

(51) Int. Cl. A01N 43/40; A01N 43/36; A01N 41/06; A01N 37/18; A01N 33/02

(52) U.S. Cl. 514/357; 514/408; 514/649; 514/620; 514/618; 514/602

(57) ABSTRACT

A pesticide having stabilized high pesticidal effects for crop plants infected with plant diseases, is presented. The pesticide contains a biphenyl derivative represented by the formula (I) or its salt, as an active ingredient: wherein X, Y and Z are each independently a halogen atom, a hydroxyl group, a formyl group, an alkyl group which may be substituted, an alkoxy group which may be substituted, an alkylthio group, an alkylsulfonyl group, an alkylsulfinyl group, or the like, A is a carbonyl group, a thiocarbonyl group, an alkylene group, or a single bond, R¹ and R² are each independently a hydrogen atom, an alkyl group which may be substituted, an alkenyl group which may be substituted, an alkynyl group which may be substituted, an aryl group which may be substituted, a formyl group, an alkylcarbonyl group, a cyano group, or the like, and m and n are each independently 0, 1, 2, 3 or 4.

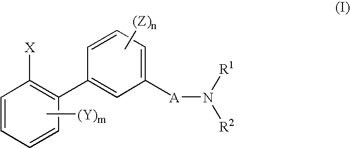

### TECHNICAL FIELD

The present invention relates to a biphenyl derivative or its salt, and a pesticide containing it as an active ingredient.

### BACKGROUND ART

W098/37068 discloses N-(3,3-dimethylbutyl)-3-(2-methoxyphenyl)benzamide and N-(3,3-dimethylbutyl)-3-(2-fluorophenyl)benzamide in the table on p. 106. Further, W099/23073, W02003/99776 and W02004/039753 disclose compounds having a biphenyl structure. However, they are not compounds to be used for agricultural or horticultural bactericides and/or fungicides.

### DISCLOSURE OF THE INVENTION

Many conventional agricultural, horticultural and pharmaceutical bactericides or fungicides have their own characteristics in their controlling effects over pests which cause plant diseases. Some have a slightly poorer curative effect as compared with a preventive effect, and some have a residual effect which lasts only for a relatively short period of time, so that their controlling effects against pests tend to be practically insufficient in some cases. Accordingly, it has been desired to develop a novel compound which has a strong controlling effect against pests which cause plant diseases.

The present inventors have conducted extensive studies to overcome the above problems and as a result, have found that use of the compound represented by the formula (I) as an active ingredient presents excellent controlling effects against various plant diseases, particularly powdery mildew of barley, wheat, vegetables, fruits and flowering plants, downy mildew of vegetables and fruits, and rice blast. Thus, the present invention has been accomplished.

Namely, the present invention provides a pesticide containing a biphenyl derivative represented by the formula (I) or its salt, as an active ingredient: 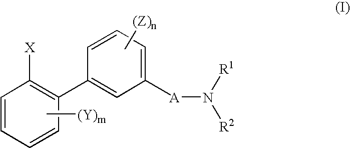
wherein, X and Y are each independently a halogen atom; a hydroxyl group; a formyl group; an alkyl group which may be substituted by halogen, alkoxy or alkylthio; a nitro group; an amino group which may be substituted by alkyl; an alkoxy group which may be substituted by halogen or alkoxy; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; an alkylsulfinyl group; or an imino group which may be substituted by alkyl or alkoxy,

Z is a halogen atom; a formyl group; an alkyl group which may be substituted by halogen; an alkoxy group which may be substituted by alkoxy; an alkylthio group; an alkylsulfonyl group; or an alkylsulfinyl group,

A is a carbonyl group; a thiocarbonyl group; an alkylene group; or a single bond,

R¹ and R² are each independently a hydrogen atom; an alkyl group which may be substituted by halogen, cycloalkyl, phenyl, substituted phenyl, heterocycle, substituted heterocycle, alkylthio, alkoxy or cyano; an alkenyl group which may be substituted by halogen, cycloalkyl, phenyl or cyano; an alkynyl group which may be substituted by halogen, cycloalkyl, phenyl or cyano; a cycloalkyl group which may be substituted by halogen or alkyl; an aryl group which may be substituted by halogen, alkyl or haloalkyl; a heterocyclic group which may be substituted by halogen, alkyl or haloalkyl; an alkylcarbonyl group which may be substituted by halogen; an alkenylcarbonyl group; an imino group; an amino group which may be substituted by alkyl; an aminocarbonyl group which may be substituted by alkyl; an alkylcarbonylamino group; a formyl group; or a cyano group, and m and n are each independently 0, 1, 2, 3 or 4.

The halogen atom contained in the formula (I) may, for example, be fluorine, chlorine, bromine or iodine, preferably fluorine, chlorine or bromine.

The alkyl moiety contained in the formula (I) may, for example, be C₁₋₆ alkyl (such as methyl, ethyl, propyl, isopropyl, butyl, isobutyl or t-butyl).

The alkenyl moiety contained in the formula (I) may, for example, be C₂₋₆ alkenyl (such as vinyl, allyl, isopropenyl or 3-methyl-2-butenyl).

The alkynyl moiety contained in the formula (I) may, for example, be C₂₋₆ alkynyl (such as 2-propynyl or 2-butynyl).

The cycloalkyl moiety contained in the formula (I) may, for example, be C₃₋₆ cycloalkyl (such as cyclopropyl, cyclopentyl or cyclohexyl).

The aryl moiety contained in the formula (I) may, for example, be C₆₋₁₀ aryl (such as phenyl or naphthyl). Further, the heterocyclic moiety contained in the formula (I) may, for example, be pyridyl, thienyl, furanyl or thiazolyl. Further, the substituents on the substituted phenyl and substituted heterocycle contained in the formula (I) may, for example, be halogen, alkyl, haloalkyl, alkoxy or-haloalkoxy.

In a case where a plurality of substituents Y are present in the formula (I), the plurality of Y may be the same or different substituents. m representing the number of substituents Y, is preferably 2, and it is particularly preferred that one Y is substituted at the para position to X, and the other Y is substituted at the ortho position to the bonding position of the two phenyl rings.

In a case where a plurality of substituents Z are present in the formula (I), the plurality of Z may be the same or different substituents. n representing the number of substituents Z, is preferably 0.

### EFFECT OF THE INVENTION

The biphenyl derivative represented by the formula (I) or its salt exhibits excellent effects as an active ingredient for-a pesticide such as an agricultural or horticultural bactericide, or a fungicide.

### BEST MODE FOR CARRYING OUT THE INVENTION

Preferred embodiments of the biphenyl derivative of the formula (I) or its salt, will be shown below.

(1) A biphenyl derivative of the formula (I) or its salt, wherein X is a chlorine atom; a bromine atom; an iodine atom; a hydroxyl group; a formyl group; an alkyl group which may be substituted by halogen, alkoxy or alkylthio; a nitro group; an amino group which may be substituted by alkyl; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; or an alkylsulfinyl group, Y is a halogen atom; a hydroxyl group; a formyl group; an alkyl group which may be substituted by halogen, alkoxy or alkylthio; a nitro group; an amino group which may be substituted by alkyl; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; or an alkylsulfinyl group, Z is a halogen atom; a formyl group; or an alkyl group which may be substituted by halogen, A is a carbonyl group; a thiocarbonyl group; or a single bond, and each of m and n which are independent of each other, is 0, 1, 2, 3 or 4.

(2) A biphenyl derivative of the formula (I) or its salt, wherein m is 2, and one Y is substituted at the para position to X, and the other Y is substituted at the ortho position to the bonding position of the two phenyl rings.

(3) The biphenyl derivative or its salt according to (1), wherein m is 2, and one Y is substituted at the para position to X, and the other Y is substituted at the ortho position to the bonding position of the two phenyl rings.

(4) A biphenyl derivative of the formula (I) or its salt, wherein X is a chlorine atom; a bromine atom; an iodine atom; a hydroxyl group; a formyl group; an alkyl group which may be substituted by halogen, alkoxy or alkylthio; a nitro group; an amino group which may be substituted by alkyl; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; or an alkylsulfinyl group, Y is a halogen atom; a hydroxyl group; a formyl group; an alkyl group which may be substituted by halogen, alkoxy or alkylthio; a nitro group; an amino group which-may be substituted by alkyl; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; or an alkylsulfinyl group, and A is a thiocarbonyl group or a single bond.

(5) A biphenyl derivative or its salt according to (1) wherein X is a hydroxyl group; a formyl group; an alkyl group which may be substituted by halogen, alkoxy or alkylthio; a nitro group; an amino group which may be substituted by alkyl; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio grpup; an alkylsulfonyl group; or an alkylsulfinyl group.

(6) A biphenyl derivative of the formula (I) or its salt, wherein each of X and Y which are independent of each other, is a halogen atom; a hydroxyl group; a formyl group; an alkyl group which may be substituted by halogen, alkoxy or alkylthio; a nitro group; an amino group which may be substituted by alkyl; an alkoxy group which may be substituted by alkoxy; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; an alkylsulfinyl group; or an imino group which may be substituted by alkyl or alkoxy, Z is a halogen atom; a formyl group; an alkyl group which may be substituted by halogen; an alkoxy group which may be substituted by alkoxy; an alkylthio group; an alkylsulfonyl group; an alkoxy group which may be substituted by alkoxy; an alkylthio group; an alkylsulfonyl group; or an alkylsulfinyl group, A is a carbonyl group; a thiocarbonyl group; or a single bond, each of R¹ and R² which are independent of each other, is an alkyl group which may be substituted by halogen, cycloalkyl, phenyl, substituted phenyl, heterocycle, substituted heterocycle, alkylthio, alkoxy or cyano; an alkenyl group which may be substituted by halogen, cycloalkyl, phenyl or cyano; an alkynyl group which may be substituted by halogen, cycloalkyl, phenyl or cyano; a cycloalkyl group which may be substituted by halogen or alkyl; an aryl group which may be substituted by halogen, alkyl or haloalkyl; a heterocyclic group which may be substituted by halogen, alkyl or haloalkyl; an alkylcarbonyl group which may be substituted by halogen; an alkenylcarbonyl group; an imino group; an amino group which may be substituted by alkyl; an aminocarbonyl group which may be substituted by alkyl; an alkylcarbonylamino group; a formyl group; or a cyano group.

(7) A biphenyl derivative or its salt according to (6), wherein Z is a halogen atom; a formyl group; or an alkyl group which may be substituted by halogen.

(8) A biphenyl derivative or its salt according to (7), wherein X is a hydroxyl group; a formyl group; an alkyl group which may be substituted by alkoxy or alkylthio; a nitro group; an amino group which may be substituted by alkyl; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; or an alkylsulfinyl group.

(9) A biphenyl derivative or its salt according to (1), wherein in the formula (I), A is a carbonyl group or a single bond (provided that N-(3,3-dimethylbutyl)-3-(2-methoxyphenyl)benzamide and N-(3,3-dimethylbutyl)-3-(2-fluorophenyl)benzamide are excluded.)

(10) A biphenyl derivative of the formula (I) or its salt, wherein A is a-carbonyl group or a single bond, and each of R¹ and R² which are independent of each other, is an alkyl group which may be substituted by halogen, cycloalkyl, phenyl, alkylthio, alkoxy or cyano; an alkenyl group which may be substituted by halogen, cycloalkyl, phenyl or cyano; an alkynyl group which may be substituted by halogen, cycloalkyl, phenyl or cyano; an aryl group which may be substituted by halogen, alkyl or haloalkyl; an alkylcarbonyl group; a formyl group; or a cyano group.

The compound of the formula (I) or its salt may be prepared by various known syntheses by utilizing characteristics based on the basic skeleton or types of the substituents. For example, in a case where the compound of the formula (I) has a substituent such as an amino group, a hydroxyl group or a carboxyl group, in the stage of the starting material or the intermediate, such a substituent may be protected by a protective group or may be substituted by a substituent which can readily be converted to such a substituent, whereby the preparation may efficiently be carried out. Such a protective group may, for example, be one disclosed, for example, by T. W. Greene, P. G. M. Wuts, in “Protective Groups in Organic Synthesis” (3rd Edition, .1999). Such protective groups may suitably be selected for use depending upon the reaction conditions. In the method of employing such a protective group, after carrying out the reaction by using such a protective group, the protective group may be removed or converted to a desired group, as the case requires, to obtain a desired compound. The reaction may be carried out by using a method known to those skilled in the art, such as usual esterification, amidation, dehydration, diazotization, oxidation, etc.

Preferred embodiments of the process for producing the compound of the formula (I) will now be described.

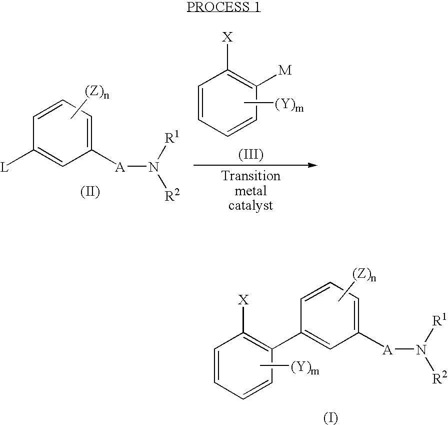

In the above reaction formulae, X, Y, Z, m, n, A, R¹ and R² are as defined above, L is a leaving group, and M is a metal.

As shown by the above flow, the compound of the formula (I) may be prepared by coupling a compound of the formula (II) with a compound of the formula (III) in the presence of a transition metal catalyst. The reaction may be carried out in accordance with a known method (e.g. Comprehensive Organic Synthesis, Volume 3, 481, 1991 or Synthetic Communications, Volume 11, 513, 1981). The leaving group represented by L in the formula (II) may, for example, be halogen or trifluoromethane sulfonyloxy, and the metal represented by M in the formula (III) may, for example, be hydroxyboron, alkylboron, alkoxyboron, halogenated magnesium, halogenated zinc, alkyltin, alkylsilicon, alkoxysilicon, halogenated silicon, alkylaluminum or halogenated aluminum. The transition metal catalyst to be used for the reaction, means a transition metal compound or a complex of a transition metal compound with an optional ligand. It may, for example, be palladium/carbon (Pd/C), tetrakis(triphenylphosphine)palladium(0), bis(dibenzylideneacetone)palladium(0), tetrakis(dibenzylideneacetone)palladium(0), palladium(II) acetate/triphenylphosphine, palladium(II) acetate/tricyclohexylphosphine, dichloropalladium(II)/I1,1′-bis(dicyclohexylphosphino)ferrocene, tetrakis(triphenylphosphine)nickel(0), bis(1,5-cyclooctadiene)nickel(0), nickel acetylacetonate(II), dichlorobis(triphenylphosphine)nickel(II) or tetrakis(triphenylphosphine)platinum(0). In the case of a metal catalyst, one preliminarily isolated may be employed, or a transition metal compound and a ligand are mixed in an optional solvent for reaction and may be used without isolation. The transition metal catalyst may be used in a ratio of from 0.001 to 0.2 equivalents, preferably from 0.01 to 0.1 equivalent, to the compound of the formula (II). Further, the reaction may be carried out in the absence or presence of a solvent not to hinder the reaction, for example, a ketone such as acetone, methyl ethyl ketone or cyclohexanone; an ether such as diethyl ether, diisopropyl ether, tetrahydrofuran, 1,4-dioxane, dimethoxyethane or diethylene glycol dimethyl ether; an ester such as ethyl acetate or methyl acetate; an alcohol such as methanol, ethanol, n-propanol or isopropanol; an aromatic hydrocarbon such as benzene, chlorobenzene, nitrobenzene or toluene; a nitrile such as acetonitrile; N,N-dimethylformamide; N,N-dimethylacetamide; dimethylsulfoxide; or water. In some cases, two or more such solvents may be used in combination as a mixed solvent.

At the time of the reaction, the compound of the formula (II) and the compound of the formula (III) may be used in equal equivalent amounts or, one may be used in excess of the other. Further, in some cases, it may be advantageous to carry out the reaction in the presence of a base to let the reaction proceed smoothly. Such a base may, for example, be an alkali metal carbonate such as sodium carbonate, potassium carbonate or cesium carbonate; an alkali metal hydrogencarbonate such as sodium hydrogencarbonate; an alkaline earth metal carbonate such as calcium carbonate; an alkali metal hydroxide such as sodium hydroxide or potassium hydroxide; an alkaline earth metal hydroxide such as calcium hydroxide; an inorganic salt such as cesium fluoride or potassium fluoride, or triethylamine, pyridine or 4-(N,N-dimethylamino)pyridine. The base is used usually in a ratio of from 1.0 to 20 equivalents, preferably from 1.0 to 3.0 equivalents, to the compound of the formula (II).

The reaction temperature is usually from −70° C. to 300° C., preferably from 0° C. to the boiling point of the solvent to be used. The reaction time varies depending upon the reaction temperature, the quantity for reaction, the reaction pressure, etc., but it is usually selected within a range of from 1 to 72 hours.

Process 2

The compound of the formula (I-1) i.e. the formula (I) wherein A is a carbonyl group, may be prepared also by the following process.

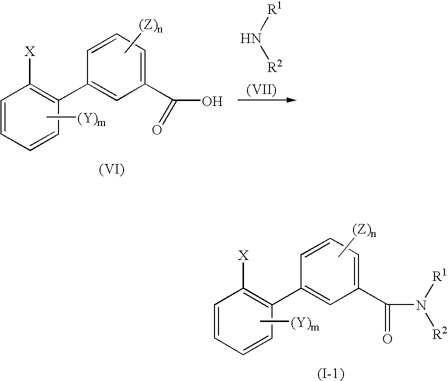

In the reaction formulae, X, Y, Z, m, n, R¹ and R² are as defined above.

As shown by the above flow, the compound of the formula (I-1) may be prepared by an amidation reaction of a compound of the formula (VI) with a compound of the formula (VII).

The amidation reaction may be carried out by condensing the compound of the formula (VI) with the compound of the formula (VII) in the presence of a condensing agent. Such a condensing agent may, for example, be dicyclohexylcarbodiimide (DCC), diisopropylcarbodiimide (DIPC), 1-ethyl-3-(3-dimethylaminopropyl)carbodiimide (WSC) or 1,1′-carbonylbis-1H-imidazole (CDI). A solvent which may be used, may, for example, be an aromatic hydrocarbon such as benzene, toluene or xylene, an ether such as diethyl ether, tetrahydrofuran (THF), 1,4-dioxane or dimethoxyethane, a halogenated hydrocarbon such as dichloromethane, 1,2-dichloroethane or chloroform, N,N-dimethylformamide (DMF), N-methyl-2-pyrrolidone (NMP) or pyridine. Further, in some cases, two or more such solvents may be used in combination as a mixed solvent.

Further, the compound of the formula (I-1) may also be prepared by a method of using a reactive derivative of the compound of the formula (VI) instead of the compound of the formula (VI) in the above amidation reaction. Such a reactive derivative of the compound of the formula (VI)-may, for example, be an acid halide, an acid anhydride or an active ester. The reaction may, for example, be carried out in accordance with the method disclosed in e.g. “Jikken Kagaku Koza (4th Edition)” compiled by Japan Chemical Society, vol. 22, (1992) published by Maruzen.

Process I for Starting Material

The compound of the formula (VI) as the starting material in process 2 may be prepared by the following process.

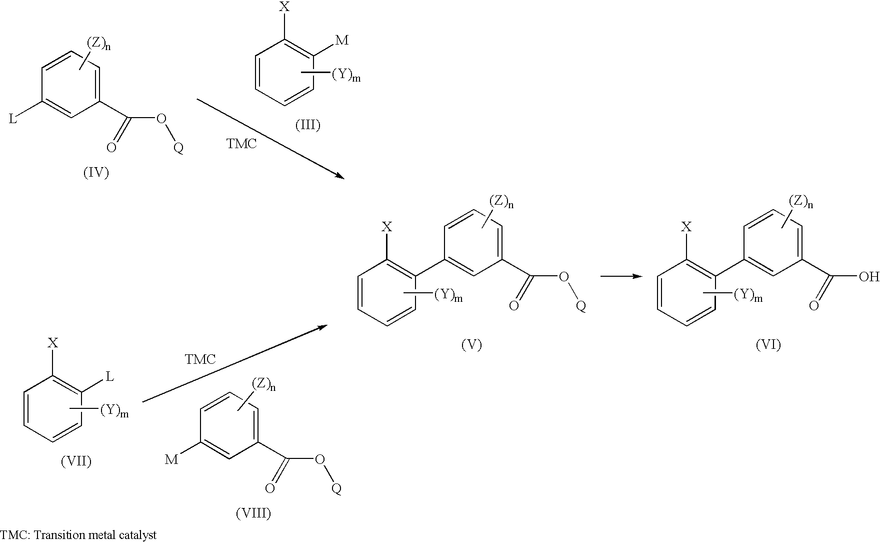

In the reaction formulae, X, Y, Z, m, n, M and L are as defined above, and Q is a hydrogen atom or a protective group for a carboxyl group.

The compound of the formula (VI) may be prepared by hydrolyzing a compound of the formula (V). Here, when Q is a hydrogen atom, the compound of the formula (V) becomes the compound of the formula (VI) by itself, whereby the hydrolysis step may be omitted. In a case where Q is a protective group for a carboxyl group, such a protective group Q may be a protective group for a carboxyl group disclosed in the above-mentioned “Protective Groups in Organic Synthesis (3rd Edition, 1999)”, and it may be removed by e.g. the protective-group-removing reaction or hydrolysis, as disclosed in the same publication.

The compound of the formula (V) can be prepared by coupling a compound of the formula (IV) with a compound of the formula (III) in the presence of a transition metal catalyst. Otherwise, the compound of the formula (V) may be prepared by coupling a compound of the formula (VII) with a compound of the formula (VIII) in the presence of a transition metal catalyst. The reaction may be carried out in the same manner as the above-described Process 1.

Process II for Starting Material

The compound of the formula (VI) as the starting material in process 2 may be prepared also by the following process.

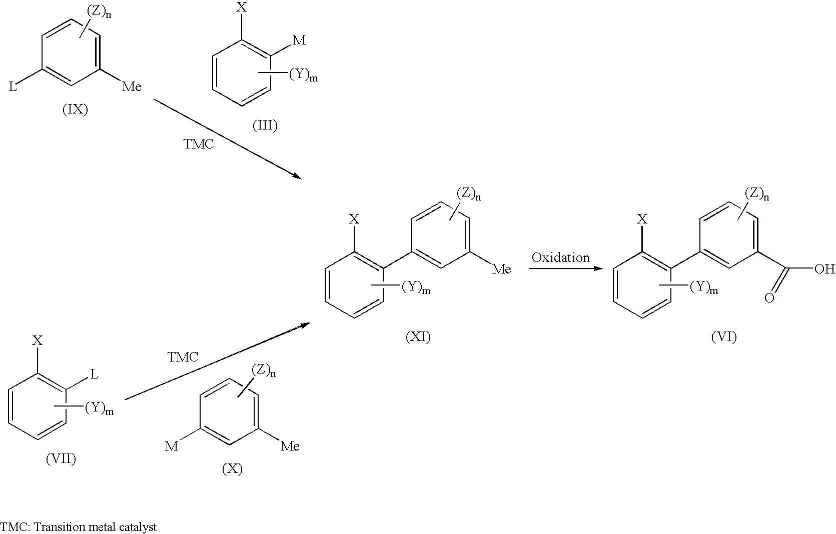

In the formula, X, Y, Z, m, n, M and L are as defined above.

The compound of the formula (VI) may be prepared by oxidizing a compound of the formula (XI) by a usual method by means of an oxidizing agent such as manganese dioxide or potassium permanganate. The compound of the formula (XI) may be prepared by coupling a compound of the formula (IX) with a compound of the formula (III) in the presence of a transition metal catalyst. Otherwise, the compound of the formula (XI) may be prepared by coupling a compound of the formula (VII) with a compound of the formula (X) in the presence of a transition metal catalyst. Both of the coupling reactions may be carried out in the same manner as the above-described Process 1.

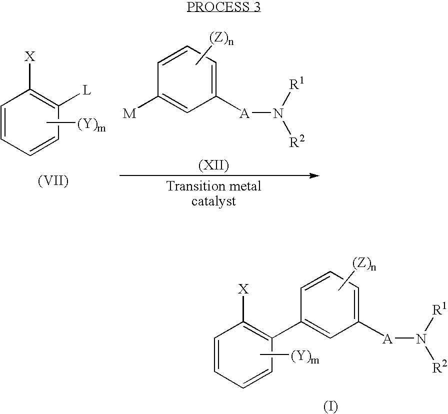

In the reaction formulae, X, Y, Z, m, n, A, R¹ and R² are as defined above, L is a leaving group, and M is a metal.

As shown by the above flow, the compound of the formula (I) may be prepared by coupling a compound of the formula (VII) with a compound of the formula (XII) in the presence of a transition metal catalyst. The reaction may be carried put in accordance with the reaction disclosed in Process 1.

The compound of the formula (I) produced by any one of Processes 1 to 3, or an intermediate formed during its preparation, may be isolated or purified by using a usual chemical operation such as extraction, concentration, distillation, crystallization, filtration, recrystallization, various chromatography, etc.

The above-described biphenyl derivative or its salt (hereinafter referred to as the compound of the present invention) is useful as an active ingredient for a pesticide such as an agricultural, horticultural or pharmaceutical bactericide and/or a fungicide, and it is particularly useful as an active ingredient for an agricultural or horticultural bactericide. As the agricultural or horticultural bactericide, it is effective for controlling diseases such as blast, brown spot or sheath blight of rice (Oryza sativa); powdery mildew, scab, rust, snow mold, loose smut, eyespot, leaf spot or glume blotch of barley (Hordeum vulgare) and wheat (Tricum aestivum); melanose or scab of citrus (Citrus); blossom blight, powdery mildew, Altenaria leaf spot or scab of apple (Malus pumila); scab or black spot of pear (Pyrus serotina, Pyrus ussuriensis, Pyrus communis); brown rot, scab or Fomitopsis rot of peach (Prunus persica); Anthracnose, ripe rot, powdery mildew or downy mildew of grape (Vitis vinifera); anthracnose or circular leaf spot of Japanese persimmon (Diospyros kaki); anthracnose, powdery mildew, gummy stem blight or downy mildew of cucurbit (Cucumis melo); early blight, leaf mold or late blight of tomato (Lycopersicon esculentum); leaf blight of cress (Brassica sp., Raphanus sp., etc); early blight or late blight of potato (Solanum tuberosum); powdery mildew of strawberry (Fragaria chiloensis); gray mold or stem rot of various crops. It shows an excellent controlling effect particularly on powdery mildew of barley; wheat and vegetables and downy mildew of vegetables. Further, it is also effective for controlling soil-borne diseases caused by phytopathogenic fungi such as Fusarium, Pythium, Rhizoctonia, Verticillium and Plasmodiophora. As the bactericides for pharmaceutical, it is effective against e.g. Candida, Cryptococcus, Aspergillus, Staphylococcus or Trichophyton.

The compound of the present invention may be used in combination with various agricultural adjuvants to formulate various formulations, such as a dust, granules, a granular wettable powder, a wettable powder, an aqueous suspension, an oil suspension, a water soluble powder, an emulsifiable concentrate, an aqueous solution, a paste, an aerosol or a microdose dusting powder. The compound of the present invention may be formed into any formulation which is usually used in the agricultural or horticultural field so long as the purpose of the present invention is met. The adjuvant to be used for formulations may, for example, be a solid carrier such as diatomaceous earth, hydrated lime, calcium carbonate, talc, white carbon, kaolin, bentonite, a mixture of kaolinite and sericite, clay, sodium carbonate, sodium bicarbonate, glauber's salt, zeolite or starch; a solvent such as water, toluene, xylene, solvent naphtha, dioxane, acetone, isophorone, methyl isobutyl ketone, chlorobenzene, cyclohexane, dimethylsulfoxide, dimethylformamide, dimethylacetamide, N-methyl-2-pyrrolidone or an alcohol; an anionic surfactant or spreading agent such as a fatty acid salt, a benzoate, an alkyl sulfosuccinate, a dialkyl sulfosuccinate, a polycarboxylate, an alkyl sulfuric ester salt, an alkyl sulfate, an alkyl aryl sulfate, an alkyl diglycol ether sulfate, an alcohol sulfuric ester salt, an alkyl sulfonate, an alkyl aryl sulfonate, an aryl sulfonate, a lignin sulfonate, an alkyl diphenyl ether disulfonate, a polystyrene sulfonate, an alkyl phosphoric ester salt, an alkyl aryl phosphate, a styryl aryl phosphate, a polyoxyethylene alkyl ether sulfuric ester salt, a polyoxyethylene alkyl aryl ether sulfate, a polyoxyethylene alkyl aryl ether sulfuric ester salt, a polyoxyethylene alkyl ether phosphate, a polyoxyethylene alkyl aryl phosphoric ester salt or a salt of a naphthalene sulfonic acid formalin condensate; a non-ionic surfactant or spreading agent such as a sorbitan fatty acid ester, a glycerol fatty acid ester, a fatty acid polyglyceride, a fatty acid alcohol polyglycol ether, an acetylene glycol, an acetylene alcohol, an oxyalkylene block polymer, a polyoxyethylene alkyl ether, a polyoxyethylene alkyl aryl ether, a polyoxyethylene styryl aryl ether, a polyoxyethylene glycol alkyl ether, a polyoxyethylene fatty acid ester, a polyoxyethylene sorbitan fatty acid ester, a polyoxyethylene glycerol fatty acid ester, a polyoxyethylene hardened caster oil or a polyoxypropylene fatty acid ester; vegetable oil or mineral oil such as olive oil, kapok oil, caster oil, palm oil, camellia oil, coconut oil, sesame oil, corn oil, rice bran oil, peanut oil, cotton oil, soy bean oil, rape oil, linseed oil, tung oil or liquid paraffin. Such an adjuvant may be selected for use from adjuvants which are known in the agricultural or horticultural field within a range of not departing from the object of the present invention. Further, an adjuvant which is usually used may also be employed, such as a bulking agent, a thickener, an anti-settling agent, a freeze proofing agent, a dispersion stabilizer, a crop injury-reducing agent or a mildew proofing agent. The blending proportion of the compound of the present invention to the adjuvant is generally from 0.005:99.995 to 95:5, preferably from 0.2:99.8 to 90:10. These formulations can be practically used either as they are or after they are diluted with a diluent such as water to predetermined concentrations, and a spreading agent may be added thereto as the case requires.

The concentration of the compound of the present invention varies depending upon the crop plant as the object, the way of application, the type of formulation or the dose, and hence cannot be generically defined. However, in the case of foliage treatment, the concentration of the compound as the active ingredient is usually from 0.1 to 10,000 ppm, preferably from 1 to 2,000 ppm. In the case of soil treatment, it is generally from 10 to 100,000 g/ha, preferably from 200 to 20,000 g/ha.

The formulation containing the compound of the present invention or a diluted product thereof may be applied by an application method which is commonly used, such as spreading (spreading, spraying, misting, atomizing, grain diffusing or application on water surface), soil application (such as mixing or irrigation) or surface application (such as coating, dust coating or covering). Further, it may be applied also by so-called ultra low volume. In this method, the formulation may contain 100% of the active ingredient.

The compound of the present invention may be used in admixture or combination with e.g. another agricultural chemical such as a fungicide, an insecticide, a miticide, a nematicide, an antiviral agent, an attractant, an herbicide or a plant growth regulator. In such a case, a still more excellent effect may be obtained in some cases.

The active ingredient compound (common name; including some which are under application) of the fungicide in such another agricultural chemical, may, for example, be:

a pirimidinamine compound such as Mepanipyrim, Pyrimethanil or Cyprodinil;

a piridinamine compound such as Fluazinam;

an azole compound such as Triadimefon, Bitertanol, Triflumizole, Etaconazole, Propiconazole, Penconazole, Flusilazole, Myclobutanil, Cyproconazole, Tebuconazole, Hexaconazole, Furconazole-cis, Prochloraz, Metconazole, Epoxiconazole, Tetraconazole, Oxpoconazole fumarate, Sipconazole, Prothioconazole, Triadimenol, Flutriafol, Difenoconazole, Fluquinconazole, Fenbuconazole, Bromuconazole, Diniconazole, Tricyclazole, Probenazole or Simeconazole;

a quinoxaline compound such as Quinomethionate;

a dithiocabamate compound such as Maneb, Zineb, Mancozeb, Polycarbamate, Metiram or Propineb;

an organic chlorine compound such as Fthalide, Chlorothalonil or Quintozene;

an imidazole compound such as Benomyl, Thiophanate-Methyl, Carbendazim or Cyazofamid;

a cyano acetamide compound such as Cymoxanil;

a phenylamide compound such as Metalaxyl, Metalaxyl M, oxadixyl, Ofurace, Benalaxyl, Furalaxyl or Cyprofuram;

a sulfenic acid compound such as Dichlofluanid;

a copper compound such as Cuprichydroxide or Oxine Copper;

an isoxazole compound such as Hymexazol;

an organic phosphorus compound such as Fosetyl-Al, Tolcofos-Methyl, S-benzyl O,O-diisopropylphosphorothioate, O-ethyl S,S-diphenylphosphorodithioate or aluminum ethylhydrogen phosphonate;

an N-halogenothioalkyl compound such a Captan, Captafol or Folpet;

a dicarboxyimide compound such as Procymidone, Iprodione or Vinclozolin;

a benzanilide compound such as Flutolanil, Mepronil, Zoxamid or Tiadinil;

a piperazine compound such as Triforine;

a pyridine compound such as Pyrifenox;

a carbinol compound such as Fenarimol or Flutriafol;

a piperidine compound such as Fenpropidine;

a morpholine compound such as Fenpropimorph or Spiroxamine;

an organic tin compound such as Fentin Hydroxide or Fentin Acetate;

a urea compound such as Pencycuron;

a cinnamic acid compound such as Dimethomorph or Flumorph;

a phenylcarbamate compound such as Diethofencarb;

a cyanopyrrole compound such as Fludioxonil or Fenpiclonil;

a strobilurin compound such as Azoxystrobin, Kresoxim-Methyl, Metominofen, Trifloxystrobin, Picoxystrobin, Oryzastrobin, Dimoxystrobin or Fludxastrobin;

an oxazolidinone compound such as Famoxadone;

a thiazolecarboxamide compound such as Ethaboxam;

a silylamide compound such as Silthiopham;

an amino acid amide carbamate compound such as Iprovalicarb or Benthiavalicarb;

an imidazolidine compound such as Fenamidone;

a hydroxyanilide compound such as Fenhexamide;

a benzenesulfonamide compound such as Flusulfamide;

an oxime ether compound such as Cyflufenamide;

a phenoxyamide compound such as Fenoxanil;

an anthraquinone compound;

a crotonic acid compound; or

an antibiotic such as Polyoxins;

a guanidine compound such as Iminoctadine;

other compound, such as Isoprothiolane, Pyroquilon, Diclomezine, Quinoxyfen, Propamocarb Hydrochloride, Chloropicrin, Dazomet, Metam-sodium, Nicobifen, Metrafenone, MTF-753, UBF-307, Diclocymet or Proquinazid.

The active ingredient compound (common name; including some which are under application) of the insecticide, miticide or nematicide i.e. the pesticide of such another agricultural chemical, may, for example, be an organic phosphate compound such as Profenofos, Dichlorvos, Fenamiphos, Fenitrothion, EPN, Diazinon, Chlorpyrifos-methyl, Acephate, Prothiofos, Fosthiazate, Phosphocarb, Cadusafos or Dislufoton;

a carbamate compound such as Carbaryl, Propoxur, Aldicarb, Carbofuran, Thiodicarb, Methomyl, Oxamyl, Ethiofencarb, Pirimicarb, Fenobucarb, Carbosulfan or Benfuracarb;

a nelicetoxin derivative such as Cartap or Thiocyclam;

an organic chlorine compound such as Dicofol and Tetradifon;

an organic metal compound such as Fenbutatin Oxide;

a pyrethroid compound such as Fenvalerate, Permethrin, Cypermethrin, Deltamethrin, Cyhalothrin, Tefluthrin, Ethofenprox, Flufenprox or Imidate;

a benzoyl urea compound such as Diflubenzuron, Chlorfluazuron, Teflubenzuron, Flufenoxuron, Bristrifluron or Noviflumuron;

a juvenile hormone-like compound such as Methoprene;

a pyridazinone compound such as Pyridaben;

a pyrazole compound such as Fenpyroximate, Fipronil, Tebufenpyrad, Ethiprole, Tolefenpyrad or Acetoprole;

a neonicotinoide such as Imidacloprid, Nitenpyram, Acetamiprid, Thiacloprid, Thiamethoxam, Clothianidin, Nidinotefuran or Dinotefuran;

a hydrazine compound such as Tebufenozide, Methoxyfenozide or Chromafenozide;

a pyridine compound such as Pyridaryl or Flonicamid;

a tetronic acid compound such as Spirodiclofen;

a strobilurin compound such as Fluacrypyrin;

a pyridinamine compound such as Flufenerim;

a dinitro compound, an organosulfur compound, a urea compound, a triazine compound, a hydrozone compound or other compounds such as Buprofezin, Hexythiazox, Amitraz, Chlordimeform, Silafluofen, Triazamate, Pymetrozine, Pyrimidifen, Chlorfenapyr, Indoxacarb, Acequinocyl, Etoxazole, Cyromazine and 1,3-dichloropropene, Verbutin, Spiromesifen, Thiazolylcinnanonitrile or Amidoflumet; AKD-1022 or IKA-2000. Further, the compound of the present invention may also be used in admixture or combination with a microbial pesticide such as a BT agent or an insect pathogenic virus agent or an antibiotic such as Avermectin, Milbemycin, Spinosad or Emamectin Benzoate.

### EXAMPLES

Now, specific Synthesis Examples of the biphenyl derivative or the intermediate for its production are described below.

### Synthesis Example 1

### Synthesis of N,N-diethyl-3-(2′,4′,6′-trimethylphenyl) benzamide (compound No. 1-1)

0.05 g of tetrakistriphenylphosphine palladium was added at room temperature to a solution having 0.26 g of 3-bromo-N,N-diethylbenzamide dissolved in 10 ml of toluene, followed by stirring for 10 minutes. 0.25 g of 2,4,6-trimethylphenyl boronic acid, 2 ml of ethanol and 3 ml of a 2M sodium carbonate solution were sequentially added thereto, and the reaction system was flushed with nitrogen, followed by reflux under heating for 2 hours.

After cooling, 50 ml of cold water was added, followed by extraction with ethyl acetate (50 ml, twice). The obtained organic layer was dried over anhydrous sodium sulfate, and then the solvent was distilled off under reduced pressure. The residue was purified by silica gel (Silica gel 60N; spherical and neutral, manufactured by Kanto Kagaku) column chromatography (developing solvent of n-hexane:ethyl acetate=2:1) to obtain 0.28 g of the objective compound as an oily substance. Further, NMR of this compound was as follows.

¹H-NMR δ (ppm) 1.15 (bs, 6H), 1.98 (s, 6H), 2.31 (s, 3H), 3.30 (bs, 2H), 3.48 (bs, 2H), 6.92 (s, 2H), 7.11 (s, 1H), 7.16 (dd, 1H; J=6.4 & 6.4 Hz), 7.34 (dd, 1H; J=1.6 & 6.4 Hz), 7.43 (dd, 1H; J=6.4 & 6.4 Hz)

### Synthesis Example 2

### Synthesis of N-methyl-3-(2′,4′,6′-trimethylphenyl)benzamide (compound No. 1-22)

(1) 180 mg of tetrakistriphenylphosphine palladium was added at room temperature to a solution having 1.15 g of ethyl 3-bromobenzoate dissolved in 20 ml of toluene, followed by stirring for 10 minutes. 4 ml of ethanol, 5.5 ml of a 2M sodium carbonate solution and 0.98 g of 2,4,6-trimethylphenyl boronic acid were sequentially added thereto, and the reaction system was flushed with nitrogen, followed by reflux under heating for 5 hours.

After cooling, 50 ml of cold water and 50 ml of ethyl acetate were added, and insoluble was filtered off. The organic layer was separated, and the water layer was extracted again with 50 ml of ethyl acetate. The organic layers were put together and dried over anhydrous sodium sulfate, and the solvent was distilled off under reduced pressure. The residue was purified by silica gel (Silica gel 60N; spherical and neutral, manufactured by Kanto Kagaku) column chromatography (developing solution of n-hexane:ethyl acetate=16:1) to obtain 1.2 g of ethyl 3-(2′,4′,6′-trimethylphenyl)benzoate having a melting point of 62.9° C. Further, NMR of this compound was as follows.

¹H-NMR δ (ppm) 1.40 (t, 3H; J=7.2 Hz), 2.00 (s, 6H), 2.35 (s, 3H), 4.38 (q, 2H: J=7.2 Hz), 6.96 (s, 2H), 7.40 (dd, 1H; J=1.2 & 7.5 Hz), 7.50 (t, 1H; J=7.5 Hz), 7.86 (d, 1H; J=1.2 Hz), 8.03 (dd, 1H; J=1.2 & 7.5 Hz)

(2) 6 ml -of a 1M sodium hydroxide aqueous solution was added at 10° C. to a solution of 1.07 g of ethyl 3-(2′,4′,6′-trimethylphenyl)benzoate obtained in (1) in 10 ml of 1,4-dioxane, and the mixture was stirred at 10° C. for 1 hour and then at from 60 to 70° C. overnight.

After cooling, 1,4-dioxane was distilled off under reduced pressure, and 50 ml of ethyl acetate and 30 ml of a 10% ammonium chloride aqueous solution were added, followed by stirring for a while. Then, extraction with ethyl acetate was carried out twice. The organic layers were put together and dried over anhydrous sodium sulfate. Then, the solvent was distilled off under reduced pressure, followed by drying under reduced pressure to obtain 0.70 g of 3-(2′,4′,6′-trimethylphenyl)benzoic acid having a melting point of 150.2° C. Further, NMR of this compound was as follows.

¹H-NMR δ (ppm) 1.99 (s, 6H), 2.34 (s, 3H), 6.95 (s, 2H), 7.38 (d, 1H: J=7.5 Hz), 7.51 (t, 1H; J=7.5 Hz), 7.91 (s, 1H), 8.08 (d, 1H; J=7.5 Hz)

(3) 7.9 ml of thionyl chloride was added under cooling with ice to a solution of 12.0 g of 3-(2′,4′,6′-trimethylphenyl)benzoic acid obtained in (2) in 60 ml of 1,2-dichloroethane, and 5 drops of N,N-dimethylformamide were added, followed by reflux under heating for 5 hours.

After cooling, 50 ml of toluene was added, and the lo solvent was distilled off. Further, adding 50 ml of toluene, followed by distillation of the solvent, was repeated-twice, and vacuum drying was carried out to obtain 11 g of crude 3-(2′,4′,6′-trimethylphenyl)benzoyl chloride. Further, NMR of this compound was as follows.

¹H-NMR δ (ppm) 2.01 (s, 6H), 2.36 (s, 3H), 6.98 (s, 2H), 7.1-7.3 (m, 1H), 7.4-7.6 (m, 2H), 7.97 (s, 1H), 8.1-8.2 (m, 1H)

(4) 1.3 g of 3-(2′,4′,6′-trimethylphenyl)benzoyl chloride obtained in (3) was added at 0° C. dividedly in several times to 25 ml of a tetrahydrofuran solution containing 1.3 g of 40% methylamine solution in methanol. After completion of the addition, the mixture was stirred at room temperature overnight. 50 ml of ethyl acetate and 30 ml of a 10% ammonium chloride aqueous solution were added, followed by stirring for a while. Then, extraction with ethyl acetate was carried out twice. The organic layers were put together and dried over anhydrous sodium sulfate, and then, the solvent was distilled off under reduced pressure. The obtained solid was washed by n-hexane to obtain 1.04 g of the objective compound having a melting point of 142.9° C.

Further, NMR of this compound was as follows.

¹H-NMR δ (ppm) 1.96 (s, 6H), 2.33 (s, 3H), 3.01 (d, 3H; J=4.8 Hz), 6.21 (bs, 1H), 6.94 (s, 2H), 7.25-7.30 (m, 1H), 7.48 (t, 1H; J=7.5 Hz), 7.52-7.53 (m, 1H), 7.73-7.77 (m, 1H)

### Synthesis Example 3

### Synthesis of N-methyl-N-n-propyl-3-(2′,4′,6′-trimethyl phenyl)benzamide (Compound No. 1-4)

60% sodium hydride was added under cooling with ice dividedly in several times to a solution of 0.25 g of N-methyl-3-(2′,4′,6′-trimethylphenyl)benzamide obtained by SYNTHESIS EXAMPLE 2 in 12 ml of anhydrous tetrahydrofuran, followed by stirring at same temperature for 20 minutes. Then, under cooling with ice, 0.29 ml of 1-iodopropane was added, followed by stirring at room temperature overnight. After the reaction solution was cooled with ice, 50 ml of ethyl acetate and 30 ml of a 10% ammonium chloride aqueous solution were added, followed by stirring for a while. Then, extraction with ethyl acetate was carried out twice. The organic layers were put together and dried over anhydrous sodium sulfate, and the solvent was distilled off under reduced pressure. The residue was purified by silica gel (Silica gel 60N; spherical and neutral, manufactured by Kanto Kagaku) column chromatography (developing solvent of n-hexane:ethyl acetate=2:1) to obtain 0.19 g of the objective compound as an oily substance. Further, NMR of this compound was as follows.

hu 1H-NMR δ (ppm) 0.77 & 0.99 (bs each, 3H), 1.58 & 1.68 (bs each, 2H), 2.02 (s, 6H), 2.34 (s, 3H), 2.97 & 3.08 (bs each, 3H), 3.24 (bs, 1H), 3.52 (bs, 1H), 6.95 (s, 2H), 7.15-7.20 (m, 2H), 7.39 (bs, 1H), 7.46 (t, 1H; J=7.5 Hz)

### Synthesis Example 4

### Synthesis of N-methyl-3-(4′-chloro-2′,6′-dimethylphenyl)benzamide (Compound No. 1-23)

200 mg of tetrakistriphenylphosphine palladium was added under cooling with ice to a solution of 0.86 g of N-methyl-3-bromobenzamide in a mixed solvent of 10 ml of toluene and 3 ml of ethanol, followed by stirring for 20 minutes. 0.93 g of 4-chloro-2,6-dimethylbenzene boronic acid and 4.5 ml of a 2M sodium carbonate aqueous solution were added thereto, and the reaction system was flushed with nitrogen, followed by reflux under heating for 9 hours.

After cooling, 50 ml of cold water was added, and then, 50 ml of ethyl acetate was added. The precipitate was filtered off. Then, the organic layer was separated from the filtrate. The water layer was extracted again with 50 ml of ethyl acetate. The organic layers were put together and dried over anhydrous sodium sulfate, and the solvent was distilled off under reduced pressure. The residue was purified by silica gel (Silica gel 60N; spherical and neutral, manufactured by Kanto Kagaku) column chromatography (developing solvent of n-hexane:ethyl acetate=1:1) to obtain 0.40 g of the objective compound having a melting point of 137.1° C. Further, NMR of this compound was as follows.

¹H-NMR δ (ppm) 1.98 (s, 6H), 3.02 (d, 3H; J=5.1 Hz), 6.18 (bs, 1H), 7.10 (s, 2H), 7.24 (d, 1H; J=7.5 Hz), 7.49 (t, 1H; J=7.5 Hz), 7.51 (s, 1H), 7.75 (d, 1H; J=7.5 Hz)

### Synthesis Example 5

### Synthesis of N-methyl-N-propargyl-3-(4′-chloro-2′,6′-dimethylphenyl)benzylamide (Compound No. 1-14)

0.08 g of 60% sodium hydride was added under cooling with ice to a solution of 0.28 g of N-methyl-3-(4′-chloro-2′,6′-dimethylphenyl)benzamide obtained in SYNTHESIS EXAMPLE 4 in 10 ml of anhydrous tetrahydrofuran, followed by stirring at same temperature for 10 minutes. Then, under cooling with ice, 0.20 ml of propargyl bromide was added, followed by stirring at room temperature overnight. Cold water was added to the reaction system, and extraction with 50 ml of ethyl acetate was carried out twice. The organic layers were put together, washed with water again, and then, dried over anhydrous sodium sulfate, and the solvent was distilled off under reduced pressure. The residue was purified by silica gel (Silica gel 60N; spherical and neutral, manufactured by Kanto Kagaku) column chromatography (developing solvent of n-hexane:ethyl acetate=2:1). 0.23 g of the objective compound in an amorphous solid state was obtained. Further, NMR of this compound was as follows.

¹H-NMR δ (ppm) 2.00 (s, 6H), 2.29 (s, 1H), 3.10 (bs, 3H), 4.02 (bs, 1H), 4.36 (bs, 1H), 7.09 (s, 2H), 7.16-7.20 (m, 2H), 7.47 (s, 1H), 7.48 (d, 1H; J=5 Hz)

### Synthesis Example 6

### Synthesis of N-methyl-3-(2′,4′,6′-trimethylphenyl)benzylamine (Compound No. 1-27)

0.15 g of tetrakistriphenylphosphine palladium was added at room temperature to a solution having 0.8 g of N-methyl-3-bromobenzylamine dissolved in 10 ml of toluene, followed by stirring for 5 minutes. 0.76 g of 2,4,6-trimethylphenyl boronic acid, 3 ml of ethanol and 4.5 ml of a 2M sodium Carbonate aqueous solution were sequentially added to this solution, followed by stirring for 4 hours under reflux.

After cooling, 50 ml of ethyl acetate and 50 ml of a 5% ammonium chloride aqueous solution were added, followed by stirring for a while. Then, liquid separation was carried out. The water layer was further extracted with 30 ml of ethyl acetate. Then, the organic layers were put together and dried over anhydrous sodium sulfate, and the solvent was distilled off under reduced pressure. The obtained crude product was purified by silica gel (Silica gel 60N; spherical and neutral, manufactured by Kanto Kagaku) column chromatography (developing solvent of n-hexane:ethyl acetate=1:1) to obtain 0.55 g of the objective compound as an-oily substance. Further, NMR of this compound was as follows.

¹H-NMR δ (ppm) 2.00 (s, 6H), 2.08 (bs, 1H), 2.33 (s, 3H), 2.46 (s, 3H), 3.80 (s, 3H), 6.93 (s, 2H), 7.41 (d, 1H; J=7.5 Hz), 7.08 (s, 1H), 7.29 (d, 1H; J=7.5 Hz), 7.38 (t, 1H; J=7.5 Hz)

### Synthesis Example 7

### Synthesis of N-methyl-N-propargyl-3-(2′,4′,6′-trimethylphenyl)benzylamine (Compound No. 1-28)

57 mg of 60% sodium hydride was added under cooling with ice to a solution having 0.17 g of N-methyl-3-(2′,4′,6′-trimethylphenyl)benzylamine obtained in SYNTHESIS EXAMPLE 6 dissolved in 10 ml of anhydrous tetrahydrofuran, followed by stirring for 20 minutes. 0.14 ml of propargyl bromide was slowly dropwise added at a temperature of at most 5° C., followed by stirring at room temperature overnight. 20 ml of cold water was added to the reaction mixture to terminate the reaction, and extraction with 50 ml of ethyl acetate was carried out. The organic layer was dried over anhydrous sodium sulfate, and the solvent was distilled off under reduced pressure. The obtained crude product was purified by silica gel (Silica gel 60N; spherical and neutral, manufactured by Kanto Kagaku) column chromatography (developing solvent of n-hexane:ethyl acetate=4:1) to obtain 0.20 g of the objective compound as an oily substance. Further, NMR of this compound was as follows.

¹H-NMR δ (ppm) 2.09 (s, 6H), 2.40 (s, 3H), 2.43 (s, 3H), 3.39 (s, 2H), 3.69 (s, 2H), 7.00 (s, 2H), 7.12 (d, 1H; J=7.5 Hz), 7.21 (s, 1H), 7.38 (d, 1H; J=7.5 Hz), 7.44 (t, 1H; J=7.5 Hz)

### Synthesis Example 8

### Synthesis of N-methyl-6-chloro-3-(2′,4′,6′-trimethylphenyl)benzamide (Compound No. 2-12)

(1) 4.8 g of 5-bromo-2-chlorobenzoic acid was dissolved in 50 ml of 1,2-dichloroethane, and 2.2 ml of thionyl chloride and 3 drops of N,N-dimethylformamide were added at room temperature, followed by stirring for 4 hours under reflux under heating. After cooling, 30 ml of toluene was added to the reaction solution, and the reaction solution was concentrated under reduced pressure. 30 ml of toluene was again added to the residual oil, followed by concentration to obtain 5.0 g of crude 5-bromo-2-chloro benzoyl chloride.

6.2 ml of a methanol solution of 40% methyl amine was dropwise added at 0° C. to a solution having the obtained crude 5-bromo-2-chloro benzoyl chloride dissolved in 70 ml of tetrahydrofuran, followed by stirring at room temperature for 2 hours. 50 ml of ice water and 100 ml of ethyl acetate were added to the reaction solution, followed by stirring for a while. Then, liquid separation was carried out. The obtained organic layer was washed with a saturated sodium chloride aqueous solution, and dried over anhydrous sodium sulfate, and the solvent was distilled off under reduced pressure. The obtained solid was pulverized in a mixed solvent of 30 ml of n-hexane and 5 ml of diethyl ether, filtered and dried to obtain 4.8 g of crude N-methyl-6-chloro-3-bromobenzamide. Further, NMR of this compound was as follows.

¹H-NMR δ (ppm) 2.92 (d, 3H; J=2.0 Hz), 6.36 (bs, 1H), 7.17 (d, 1H; J=8.4 Hz), 7.38 (dd, 1H; J=2.4 Hz & 8.4 Hz), 7.66 (d, 1H; J=2.4 Hz)

(2) 0.15 g of tetrakistriphenylphosphine palladium was added at room temperature to a solution of 1.0 g of N-methyl-6-chloro-3-bromobenzamide obtained in (1) in 15 ml of toluene, followed by stirring for 10 minutes. 0.76 g of 2,4,6-trimethylphenyl boronic acid, 3 ml of ethanol and 4.5 ml of a 2M sodium carbonate aqueous solution were sequentially added thereto, and the reaction system was flushed with nitrogen, followed by stirring for 2 hours under reflux under heating.

After cooling, 50 ml of cold water was added, 50 ml of ethyl acetate was added, and the precipitate was filtered off. Then, the organic layer was separated from the filtrate. The water layer was extracted again with 50 ml of ethyl acetate. The organic layers were put together and dried over anhydrous sodium sulfate, and the solvent was distilled off under reduced pressure. The residue was purified by silica gel (Silica gel 60N; spherical and neutral, manufactured by Kanto Kagaku) column chromatography (developing solvent of n-hexane:ethyl acetate=2:1) to obtain 0.25 g of the objective compound having a melting point of 130.0° C. Further, NMR of this compound was as follows.

¹H-NMR δ (ppm) 1.97 (s, 6H), 2.31 (d, 3H), 2.94 (d, 1H; J=4.8 Hz), 6.54 (bs, 1H), 6.91 (s, 2H), 7.11 (dd, 1H; J=2.0 & 4.8 Hz), 7.39 (d, 1H; J=2.0 Hz), 7.39 (d, 1H; J=4.8 Hz)

### Synthesis Example 9

### Synthesis of 3-(2′,4′,6′-trimethylphenyl)acetanilide (Compound No. 1-44)

(1) 3.35 ml of triethylamine was added under stirring and cooling with ice to a solution having 3.5 g of 3-bromoaniline dissolved in 50 ml of tetrahydrofuran, and then, 1.57 ml of acetyl chloride was slowly dropwise added at a temperature of from 0 to 5° C. After the dropwise addition, the mixture was stirred at room temperature for 0.5 hour. 50 ml of ice water and 100 ml of ethyl acetate were added to the reaction solution, followed by stirring for a while. Then, liquid separation was carried out. The obtained organic layer was washed with a saturated sodium chloride aqueous solution, and dried over anhydrous sodium sulfate, and the solvent was distilled off under reduced pressure. The obtained residue was purified by silica gel (Silica gel 60N; spherical and neutral, manufactured by Kanto Kagaku) column chromatography (developing solvent of n-hexane:ethyl acetate=2:1) to obtain 3.6 g of 3-bromoacetoanilide as white crystals. Further, NMR of this compound was as follows.

¹H-NMR δ (ppm) 2.18 (s, 3H), 7.20-7.40 (m, 3H), 7.41 (d, 1H; J=7.8 Hz), 7.75 (s, 1H)

(2) 0.05 g of tetrakistriphenylphosphine palladium was added at room temperature to a solution having 0.21 g of 3-bromo-acetoanilide obtained by (1) dissolved in 5 ml of toluene, followed by stirring for 15 minutes. 0.25 g of 2,4,6-trimethylphenyl boronic acid, 2 ml of ethanol and 3 ml of a 2M sodium carbonate solution were sequentially added thereto, and the reaction system was flushed with is nitrogen, followed by stirring for 12 hours under reflux under heating.

After cooling, 10 ml of cold water was added, followed by extraction with 15 ml and 10 ml of ethyl acetate. The organic layers were put together and dried over anhydrous sodium sulfate, and then the solvent was distilled off under reduced pressure. The residue was purified by silica gel (Silica gel 60N; spherical and neutral, manufactured by Kanto Kagaku) column chromatography (developing solvent of n-hexane:ethyl acetate=2:1) to obtain 0.15 g of the objective compound having a melting point of 173.8° C. Further, NMR of this compound was as follows.

¹H-NMR δ (ppm) 1.98 (s, 6H), 2.15 (s, 3H), 2.30 (s, 3H), 6.85 (d, 1H; J=8.0 Hz), 6.90 (s, 2H), 7.16 (s, 1H), 7.33 (t, 1H; J=8.0 Hz), 7.41 (bs, 1H), 7.57 (d, 1H; J=8.0 Hz),

### Synthesis Example 10

### Synthesis of N-methyl-N-3-(2′,4′,6′-trimethylphenyl)benzylacetamide (Compound No. 1-41)

(1) 3.4 ml of triethylamine was added with stirring under cooling with ice to a solution having 2.25 g of 3-bromobenzylamine hydrochloride dissolved in 30 ml of tetrahydrofuran, followed by stirring for 40 minutes at room temperature. Then, 0.86 ml of acetyl chloride was slowly dropwise added at 10° C. After completion of the dropwise addition, the mixture was stirred for 1 hour at room temperature. 50 ml of ice water and 100 ml of ethyl acetate were added to the reaction solution, followed by stirring for a while. Then, liquid separation was carried out. The obtained organic layer was washed with a 2% ammonium chloride aqueous solution and a saturated sodium chloride aqueous solution and dried over anhydrous sodium sulfate, and the solvent was distilled off under reduced pressure. The obtained residue was purified by silica gel (Silica gel 60N; spherical and neutral, manufactured by Kanto Kagaku) column chromatography (developing solvent of n-hexane:ethyl acetate=1:4) to obtain 2.05 g of N-3-bromobenzylacetamide as white crystals. Further, NMR of this compound was as follows.

¹H-NMR δ (ppm) 2.03 (s, 3H), 4.38 (d, 2H; J=5.7 Hz), 6.07 (bs, 1H), 7.17-7.2 (m, 2H), 7.36-7.41 (m, 2H)

(2) 0.23 g of 60% sodium hydride was added under cooling with ice to a solution having 1.15 g of N-3-bromo benzylacetamide obtained in (1) dissolved in 20 ml of anhydrous tetrahydrofuran, followed by stirring for 10 minutes at same temperature. Then, 0.63 ml of iodomethane was added thereto under cooling with ice, followed by stirring for 3.5 hours at room temperature. Cold water was added to the reaction system, and extraction with 50 ml of ethyl acetate was carried out twice. The organic layers were put together, washed again with water, and then, dried over anhydrous sodium sulfate, and the solvent was distilled off under reduced pressure. The residue was purified by silica gel (Silica gel 60N; spherical and neutral, manufactured by Kanto Kagaku) column chromatography (developing solvent of n-hexane:ethyl acetate=1:3) to obtain 0.95 g of N-3-bromobenzyl-N-methylacetamide as a yellow oily substrate. Further, MR of this compound was as follows.

¹H-NMR δ (ppm) 2.14 & 2.17 (s each, 3H), 2.94 (s, 3H), 4.50 & 4.55 (s each, 2H), 7.09 & 7.18 (d each, 1H; J=7.8 Hz), 7.10-7.30 (m, 1H), 7.31-7.37 (s each, 1H), 7.35-7.45 (m, 1H)

(3) 0.05 g of te-rakistriphenylphosphine palladium was added at room temperature to a solution having 0.24 g of N-3-bromobenzyl-N-methylacetamide obtained in (2) in 15 ml of toluene, followed by stirring at room temperature for 15 minutes. 0.25 g of 2,4,6-trimethylphenyl boronic acid, 2 ml of ethanol and 3 ml of a 2M sodium carbonate aqueous solution were sequentially added thereto, and the reaction system was flushed with nitrogen, followed by stirring for 12 hours under reflux under heating.

After cooling, 10 ml of cold water was added, followed by extraction with 15 ml and 10 ml of ethyl acetate. The organic layers were put together and dried over anhydrous sodium sulfate, and then the solvent was distilled off under reduced pressure. The residue was purified by silica gel (Silica gel 60N; spherical and neutral, manufactured by Kanto Kagaku) column chromatography to obtain 0.2 g of the objective compound as an oily substance. Further, NMR of this compound was as follows.

¹H-NMR δ (ppm) 1.97 (s, 6H), 2.14 (s, 3H), 2.31 & 2.32(s each, 3H), 2.91 & 2.93 (s each, 3H), 4.54 & 4.62 (s each, 3H), 6.92 & 6.93 (s each, 2H), 6.94.& 6.97 (s each, 1H), 7.03 & 7.07 (d each, 1H; J=7.6 Hz), 7.14 & 7.20(d each, 1H; J=7.6 Hz), 7.36 & 7.40 (t each, 1H; J=7.6 Hz)

### Synthesis Example 11

### Synthesis of 3-(2′,6′-dichloro-4′-methylthiophenyl)aniline (Compound No. 1-207)

0.05 g of tetrakistriphenylphosphine palladium was added at room temperature to a solution having 2.2 g of 4-bromo-3,5-dichlorothioanisole dissolved in 50 ml of toluene, followed by stirring for 10 minutes. 1.4 g of 3-aminophenyl boronic acid, 8 ml of ethanol and 9.5 ml of a 2M sodium carbonate aqueous solution were sequentially added thereto, and the reaction system was flushed with nitrogen, followed by stirring for 3.5 hours under reflux under heating.

After cooling, cold water was added, followed by extraction with ethyl acetate. The organic layer was dried over anhydrous sodium sulfate, and then the solvent was distilled off under reduced pressure. The residue was purified by silica gel (Silica gel 60N; spherical and neutral, manufactured by Kanto Kagaku) column chromatography to obtain 0.91 g of the objective compound as an oily substance. Further, NMR of this compound was as follows.

¹H-NMR δ (ppm) 2.51 (s, 3H), 3.79 (bs, 2H), 6.57 (s, 1H), 6.64 (d, 1H; J=7.8 Hz), 6.75 (d, 1H; J=7.8 Hz), 7.22 (s, 2H), 7.24 (t, 1H; J=7.8 Hz)

### Synthesis Example 12

### Synthesis of 4-(3′-aminophenyl)3,5-dimethylphenyl 5-trifluoromethyl-2-pyridyl ether (Compound No. 1-57)

0.16 g of tetrakistriphenylphosphine palladium was added at room temperature to a solution of 1.56 g of separately prepared 4-bromo-3,5-dimethylphenyl 5-trifluoromethyl-2-pyridyl ether in 40 ml of toluene, followed by stirring for 10 minutes. 0.83 g of 3-nitrophenyl boronic acid, 5 ml of ethanol and 5.4 ml of a 2M sodium carbonate aqueous solution were added thereto, and the reaction system was flushed with nitrogen, followed by stirring for about 3 hours under reflux under. heating.

After cooling, cold water was added, followed by extraction with ethyl acetate. The organic layer was dried over anhydrous sodium sulfate, and then the solvent was distilled off under reduced pressure. The residue was purified by silica gel (Silica gel 60N; spherical and neutral, manufactured by Kanto Kagaku) column. chromatography to obtain 0.48 g of 4-(3′-nitrophenyl)-3,5-dimethylphenyl 5-trifluoromethyl-2-pyridyl ether having a melting point of 100.6° C. Further, NMR of this compound was as follows.

¹H-NMR δ (ppm) 1.97 (s, 6H), 6.86 (s, 2H), 6.98 (d, 1H; J=7.8 Hz), 7.47 (d, 1H; J=7.8 Hz), 7.56 (t, 1H; J=7.8 Hz), 7.85 (dd, 1H; J=8.7 & 2.4 Hz), 8.01 (s, 1H), 8.17 (d, 1H; J=7.8 Hz), 8.42 (d, 1H; J=2.4 Hz)

(2) 0.14 g of 10% palladium carbon was added dividedly in several times at 10° C. with stirring to a solution of 1.64 g of 4-(3′-nitrophenyl)-3,5-dimethylphenyl 5-trifluoromethyl-2-pyridyl ether obtained in (1) in 20 ml of methanol. The reaction system was flushed with hydrogen, followed by vigorous stirring under pressure by hydrogen balloon at room temperature overnight. The reaction product was filtered through celite and washed thoroughly with methanol. Then, the filtrate was dried over anhydrous sodium sulfate, and methanol was distilled off under reduced pressure to obtain 0.36 g of the objective compound having a melting point of 200.3° C.

Further, NMR of this compound was as follows.

¹H-NMR δ (ppm) 2.02 (s, 6H), 3.47 (s, 2H), 6.87 (s, 2H), 7.02 (d, 1H; J=8.7 Hz), 7.24 (d, 1H; J=7.5 Hz), 7.36 (s, 1H), 7.50 (t, 1H; J=7.5 Hz), 7.54 (d, 1H; J=7.5 Hz), 7.89 (dd, 1H; J=8.7 & 2.4 Hz), 8.45 (d, 1H; J=2.4 Hz)

### Synthesis Example 13

### Synthesis of 3-(2′,6′-dimethyl-4′-(5-trifluoromethyl-2-pyridyl)oxyphenyl)acetanilide (Compound No. 1-56)

0.11 ml of triethylamine was added at 0° C. to a solution-of 0.18 g of 4-(3′-aminophenyl)-3,5-dimethylphenyl 5-trifluoromethyl-2-pyridyl ether (compound No. 1-57) obtained in SYNTHESIS EXAMPLE 12 in 10 ml of anhydrous tetrahydrofuran. Then, 0.05 ml of acetyl chloride was dropwise added at −5° C., and the mixture was gradually warmed to room temperature while stirring for 2 hours. Cold water was added, followed by extraction with ethyl acetate. The obtained organic layer was dried over anhydrous sodium sulfate, and then the solvent was distilled off under reduced pressure. The residue was purified by silica gel (Silica gel 60N; spherical and neutral, manufactured by Kanto Kagaku) column chromatography to obtain 0.10 g of the objective compound having a melting point of 174.7° C., Further, NMR of this compound was as follows.

¹H-NMR δ (ppm) 2.05 (s, 6H), 2.20 (s, 3H), 6.88 (s, 2H), 6.92 (d, 1H; J=7.5 Hz), 7.03 (d, 1H; J=8.7 Hz), 7.24 (bs, 1H), 7.30 (s, 1H), 7.38 (t, 1H; J=7.5 Hz), 7.53 (d, 1H; J=7.5 Hz), 7.91 (dd, 1H; J=8.7 & 2.4 Hz), 8.50 (d, 1H; J=2.4 Hz)

### Synthesis Example 14

### Synthesis of 3-(2′,6′-dichlorophenyl)aniline (compound No. 1-268)

(1) 0.14 g of tetrakistriphenylphosphine palladium was added at room temperature to a solution having 0.9 g of 1-bromo-2,6-dichlorobenzene dissolved in 50 ml of toluene, followed by stirring for 10 minutes. 0.8 g of 3-nitrophenyl boronic acid, 5 ml of ethanol and 4.2 ml of a 2M sodium carbonate aqueous solution were added thereto, and the reaction system was flushed with nitrogen, followed by stirring for 15 hours under reflux under heating.

After cooling, the reaction solution was filtered through celite, followed by washing thoroughly with ethyl acetate from above. Cold water was added to the filtrate, followed by extraction with ethyl acetate. The organic layer was dried over anhydrous sodium sulfate, and then the solvent was distilled off under reduced pressure. The residue was purified by silica gel (Silica gel 60N; spherical and neutral, manufactured.by Kanto Kagaku) column chromatography to obtain 0.98 g of 3-(2,6-dichlorophenyl)nitrobenzene as an oily substrate. Further, NMR of this compound was as follows.

¹H-NMR δ (ppm) 7.30 (t, 1H; J=8.1 Hz), 7.42 (d, 2H; J=8.1 Hz), 7.61 (d, 1H; J=7.8 Hz), 7.65 (t, 1H; J=7.8 Hz), 8.18 (s, 1H), 8.29 (d, 1H; J=7.8 Hz)

(2) 0.2 g of 10% palladium carbon was added dividedly in several times at 0° C. with stirring to a solution of 1.9 g of 3-(2′,6′-dichlorophenyl)nitrobenzene obtained in (1) in 40 ml of methanol. The reaction system was flushed with hydrogen, followed by stirring under pressure by hydrogen balloon at from 10 to 15° C. overnight. The reaction product was filtered through celite and washed with methanol. Then, the filtrate was dried over anhydrous sodium sulfate, and then methanol was distilled off under reduced pressure. The residue was purified by silica gel (Silica gel 60N; spherical and neutral, manufactured by Kanto Kagaku) column chromatography to obtain 0.53 g of the objective compound having a melting point of 102.0° C. Further, NMR of this compound was as follows.

¹H-NMR δ (ppm) 6.70 (s, 1H), 6.74 (d, 1H; J=7.5 Hz), 6.87 (d, 1H; J=7.5 Hz), 7.20 (t, 1H; J=7.5 Hz), 7.25 (s, 2H), 7.29 (t, 1H; J=8.1 Hz), 7.38 (d, 2H; J=8.1 Hz)

### Synthesis Example 15

### Synthesis of 3-(2′,6′-dichiorophenyl)-N-formanilide (compound No. 1-209)

0.36 g of 3-(2′,6′-dichlorophenyl)aniline (Compound. No. 1-268) obtained in SYNTHESIS EXAMPLE 14 was dissolved in 3 ml of formic acid, followed by stirring for 2.5 hours under reflux under heating. After cooling, cold water was added, followed by extraction with ethyl acetate. The mixture was dried over anhydrous sodium sulfate, and then the solvent was distilled off under reduced pressure. The residue was purified by silica gel (Silica gel 60N; spherical and neutral, manufactured by Kanto Kagaku) column chromatography to obtain 0.30 g of the objective compound having a melting point of 114.0° C. Further, NMR of this compound was as follows.

¹H-NMR δ (ppm) 7.02 (s, 1H), 7.07-7.23 (m, 2H), 7.25-7.47 (m, 3H), 7.45 & 7.66(d each, 1H; J=8.0 Hz), 8.17 & 8.37 (s each, 1H), 8.73 & 9.11 (d each, 1H; J=11.0 Hz)

### Synthesis Example 16

### Synthesis of 3-(2′,6′-dichlorophenyl)-N-formyl-N-propargylanilide (compound No. 1-216)

0.27 g of 3-(2′,6′-dichlorophenyl)-N-formanilide (Compound No. 1-209) obtained in SYNTHESIS EXAMPLE 15 was dissolved in 5 ml of N,N-dimethylformamide, and 60 mg of 60% sodium hydride was added at 5° C., followed by stirring at the same temperature for 10 minutes. 0.18 g of propargyl bromide was dropwise added thereto at 5° C., followed by stirring at room temperature overnight. Since the reaction was not complete, 60 mg of 60% sodium hydride was added at room temperature, followed by stirring at the same temperature for 1 hour, whereby most. of (2′,6′-dichlorophenyl)-N-formanilide of raw material disappeared. Cold water was added, followed by extraction with ethyl acetate. The organic layer was dried over anhydrous sodium sulfate, and then the solvent was distilled off under reduced pressure. The residue was purified by silica gel (Silica gel 60N; spherical and neutral, manufactured by Kanto Kagaku) column chromatography to obtain 0.20 g of the objective compound in an amorphous solid state. Further, NMR of this compound was as follows.

¹H-NMR δ (ppm) 2.23 (t, 1H; J=2.7 Hz), 4.56 (d, 1H; J=2.7 Hz), 7.17-7.26 (m, 3H), 7.32-7.41 (m, 3H), 7.50 (t, 1H; J=7.8 Hz), 8.47 (s, 1H)

### Synthesis Example 17

### Synthesis of N-methyl-3-(2′,6′-dichlorophenyl)-6-fluorobenzamide (compound No. 2-22)

(1) 1.1 g of tetrakistriphenylphosphine palladium was added at room temperature to a solution having 9.5 g of 5-bromo-2-fluorotoluene dissolved in 150 ml of toluene, followed by stirring for 10 minutes. 13.4 g of 2,6-dichlorophenyl boronic acid, 30 ml of ethanol, 50 ml of a 2M sodium-carbonate aqueous solution and 10.6 g of sodium carbonate powder were added thereto, and the reaction system was flushed with nitrogen, followed by stirring for 15 hours under ref lux under heating. After cooling, the reaction solution was filtered through celite, and the filtrate was dried over anhydrous sodium sulfate. Then, the solvent was distilled off under reduced pressure. The residue was purified by silica gel (Silica gel 60N; spherical and neutral, manufactured by Kanto Kagaku) column chromatography (developing solvent: n-hexane only) to obtain 6.5 g of 5-(2′,6′-dichlorophenyl)-2-fluorotoluene as an oily substrate. Further, NMR of this compound was as follows.

¹H-NMR δ (ppm) 2.34 (d, 3H; J=2.1 Hz), 7.05-7.13 (m, 3H), 7.21 (t, 1H; J=7.5 Hz), 7.39 (d, 2H; J=-7.5 Hz)

(2) 6.4 g of 5-(2′,6′-dichlorophenyl)-2-fluorotoluene obtained in (1) was dissolved in 20 ml of pyridine, 40 ml of water was added, and 20 g of potassium permanganate was added dividedly in several times with stirring at from 70 to 80° C., followed by stirring for 4.5 hours under reflux under heating. The mixture was cooled to from 70 to 80° C., filtered through celite and washed three times with 100 ml of hot water from above. The water layer obtained as the filtrate was cooled with ice, washed with diethyl ether, and then acidified by 2N hydrochloric acid with stirring. The precipitated solid was collected by filtration and dried by suction to obtain 1.5 g of 5-(2′,6′-dichlorophenyl)-2-fluorobenzoic acid having a melting. point of 175.5° C. Further, NMR of this compound was as follows.

¹H-NMR δ (ppm) 7.2-7.3 (m, 1H), 7.4-7.5. (m, 2H), 7.68 (bs, 1H), 7.95 (dd, 1H; J=6.9 & 2.4 Hz), 8.10 (t, 1H; J=7.5 Hz), 8.82 (bs, 1H)

(3) 1.2 g of 5-(2′,6′-dichlorophenyl)-2-fluorobenzoic acid obtained in (2) was dissolved in 20 ml of 1,2-dichloroethane, and 0.67 ml of thionyl chloride and 2 drops of N,N-dimethylformamide were added at room temperature, followed by stirring for 3 hours under reflux under heating. After cooling, 20 ml of toluene was added to the reaction solution, followed by concentration-under reduced pressure. 20 ml of toluene was again added to the residual oil, followed by concentration to obtain 1.35 g of crude 5-(2′,6′-dichlorophenyl)-2-fluorobenzoic chloride.

The obtained product was dissolved in 20 ml of tetrahydrofuran and, while stirring at 0° C., 1.4 ml of a methanol solution of 40% methyl amine was slowly dropwise added, followed by stirring at room temperature for 2 hours. 30 ml of ice water and 60 ml of ethyl acetate were added to the reaction solution, followed by stirring for a while, Then, liquid separation was carried out. The obtained organic layer was washed with a saturated sodium chloride aqueous solution and dried over anhydrous sodium sulfate, and then the solvent was distilled off under reduced pressure. The obtained residue was purified by silica gel (Silica gel 60N; spherical and neutral, manufactured by-Kanto Kagaku) column chromatography (developing solvent of n-hexane:ethyl acetate=2:1) to obtain 0.85 g of the objective compound having a melting point of 142.5° C. Further, NMR of this compound was as follows.

¹H-NMR δ (ppm) 3.06 (d, 3H; J=4.8 Hz), 6.80 (bs, 1H), 7.17-7.25 (m, 2H), 7.26 (d, 1H; J=7.5 Hz), 7.33-7.39 (m, 2H), 7.41 (s, 1H), 8.04 (dd, 1H; J=7.5 & 2.4 Hz)

### Synthesis Example 18

### Synthesis of N-methyl-3-(2′,6′-dichloro-3,-methylphenyl)benzamide (compound No. 1-86)

(1) 130 ml of 1.59 mol/l of n-butyl lithium was slowly dropwise added at a temperature of from −75 to −62° C. over a period of 50 minutes to a solution of 25.9 ml of 2,4-dichlorotoluene in 350 ml of anhydrous tetrahydrofuran, followed by stirring at −70° C. for 30 minutes. At a temperature of from −75 to −65° C., 31.8 ml of trimethyl borate was gradually dropwise added, followed by stirring for a while. Then, an ice bath was removed, and the mixture was stirred overnight while slowly warming it to room temperature. Then, the reaction system was cooled to 0° C., and ice water and 2N hydrochloric acid were gradually added with stirring, followed by stirring for 2 hours to room temperature. Extraction with diethyl ether was carried out (500 ml×twice). The organic layers were put together, washed with a saturated sodium chloride aqueous solution and then dried over anhydrous sodium sulfate, and then the solvent was distilled off under reduced pressure, followed by suction drying to obtain 48 g of a composition. This composition was subjected to filtration with n-hexane to obtain 15 g of crude 2,6-dichloro-3-methylbenzene boronic acid. This crude product was used as raw material for the next coupling reaction. The filtrate was also thoroughly suction-dried to obtain 22 g of a powder comprising the objective product as the main component.

(2) 850 mg of 5% palladium carbon (type E101 NO/W; Aldrich reagent) was added under cooling with ice to a solution of 2.15 g of N-methyl-3-bromobenzamide and 2.5 g of 2,6-dichloro-3-methylbenzene boronic acid obtained in (1) in 25 ml of ethanol. Then, under cooling at 0° C., 6.4 g of sodium carbonate powder was gradually added, and the reaction system was flushed with nitrogen, followed by stirring for 8 hours under reflux under heating. After cooling, 1.25 g of the above mentioned boronic acid, 430 mg of the above mentioned 5% palladium carbon and 5 ml of ethanol were further added, and the reaction system was again flushed with nitrogen, followed by reflux under heating for 12 hours. After cooling, the reaction solution was filtered through celite, the filtrate was dried over anhydrous sodium sulfate, and then the solvent was distilled off under reduced pressure. The residue was purified by silica gel (Silica gel 60N; spherical and neutral, manufactured by Kanto Kagaku) column chromatography (developing solvent of n-hexane:ethyl acetate=2:1 to 1:1) to obtain 250 mg of the objective compound having a melting point of 118.8° C. Further, NMR of this compound was as follows.

¹H-NMR δ (ppm) 2.39 (s, 3H), 2.98 (d, 3H; J=4.8 Hz), 6.41 (bs, 1H), 7.18 (d, 1H; J=8.1 Hz), 7.28 (d, 1H; J=8.1 Hz), 7.35 (d, 1H; J=7.8 Hz), 7.50 (d, 1H; J=7.8 Hz), 7.63 (s, 1H), 7.82 (d, 1H; J=7.8 Hz)

### Synthesis Example 19

### Synthesis of N-ethyl-3-(2′,6′-dichloro-3′-trifluoromethylphenyl)benzamide (compound No. 1-127)

(1) 65 ml of 1.60 mol/l of n-butyl lithium was slowly dropwise added at a temperature of from −75 to −65° C. over a period of 30 minutes to a solution of 14.8 ml of 2,4-dichlorobenzotrifluoride in 350 ml of anhydrous tetrahydrofuran, followed by stirring at −70° C. for 1 hour. At a temperature of from −75 to −65° C., 15.9 ml of trimethyl borate was gradually dropwise added, followed by stirring for a while. Then, an ice bath was removed, and the mixture was stirred for 1 hour while gradually warming it to room temperature. Then, the reaction system was cooled to 0° C., and 70 ml of. ice water and 80 ml of 2N hydrochloric acid were gradually added with stirring, followed by stirring at room temperature overnight. Extraction with diethyl ether was carried out (300 ml×twice). The organic layers were put together, washed with a saturated sodium chloride aqueous solution and then dried over anhydrous sodium sulfate, and the solvent was distilled off under reduced pressure. Suction drying was thoroughly carrieddut to obtain 28 g of crude 2,6-dichloro-3-trifluoromethylbenzene boronic acid. This product was used as raw material for the next coupling reaction.

(2) The reaction system was flushed with nitrogen, then 100 mg of tetrakistriphenylphosphine palladium was added under cooling with ice to a solution having 0.46 g of N-ethyl-3-bromobenzamide dissolved in 10 ml of toluene, followed by stirring at room temperature for 1 hour. Then, a solution of 1.8 g of 2,6-dichloro-3-trifluoromethylbenzene boronic acid obtained in (1) in 3 ml of ethanol, was added under cooling at 0° C., and 3 ml of a 2M sodium carbonate aqueous solution was added, followed by stirring for 13 hours under reflux under heating while the temperature of the oil bath was maintained exactly at 90° C.

After cooling, 7 ml of cold water was added, and the organic layer was separated, followed by extraction with 50 ml of ethyl acetate from the water layer. The organic layers were put together and dried over anhydrous sodium sulfate, and the solvent was distilled off under reduced pressure. The residue was purified by silica gel (Silica gel 60N; spherical and neutral, manufactured by Kanto Kagaku) column chromatography (developing solution of n-hexane:ethyl acetate=2:1 to 1:1) to obtain 325 mg of the objective compound having a melting point of 137.0° C. Further, NMR of this compound was as follows.

¹H-NMR δ (ppm) 1.22-1.26 (m, 3H), 3.45-3.52 (m, 2H), 6.15 (bs, 1H), 7.35 (d, 1H; J=7.6 Hz), 7.52-7.58 (m, 2H), 7.62 (s, 1H), 7.66 (d, 1H; J=8.8 Hz), 7.85 (d, 1H; J=6.8 Hz)

### Synthesis Example 20

### Synthesis of N-methyl-3-(2′,6′-dichloro-3′-trifluoromethylphenyl)benzamide (compound No. 1-120)

The objective compound having a melting point of 126.1° C. was obtained in the same manner as in SYNTHESIS EXAMPLE 19 except that N-methyl-3-bromobenzamide was used instead of N-ethyl-3-bromobenzamide. Further, NMR of this compound was as follows.

¹H-NMR δ (ppm) 3.02 (d, 3H; J=4.8 Hz), 6.22 (bs, 1H), 7.37 (d, 1H; J=7.8 Hz), 7.52 (d, 1H; J=8.4 Hz), 7.56 (t, 1H; J=7.8 Hz), 7.64 (s, 1H), 7.67 (d, 1H; J=8.4 Hz), 7.86 (d, 1H;. J=7. 8 Hz)

### Synthesis Example 21

### Synthesis of N-methyi-3-(2′,4′,6′-trimethylphenyl)thiobenzamide (compound No. 1-142)

10 g of N-methyl-3-(2′,4′,6′-trimethylphenyl)benzamide (compound No. 1-22′) obtained in SYNTHESIS EXAMPLE 2 was dissolved in 100 ml of toluene, and 9.6 g of Lawesson's Reagent was added at room temperature, followed by stirring for 3 hours under reflux under heating. Cold water was added, followed by extraction with ethyl acetate. The obtained organic layer was dried over anhydrous sodium sulfate, and the solvent was distilled off under reduced pressure. The residue was purified by silica gel (Silica gel 60N; spherical and neutral, manufactured by Kanto Kagaku) column chromatography to obtain. 1.1 g of the objective compound having a melting point of 62.5° C. Further, NMR of this compound was as follows.

¹H-NMR δ (ppm) 1.92 (s, 6H), 2.25 (s, 3H), 3.28 (d, 3H; J=4.8 Hz), 6.87 (s, 2H), 7.19 (d, 1H; J=7.5 Hz), 7.37 (t, 1H; J=7.5 Hz), 7.44 (s, 1H), 7.71 (d, 1H; J=7.5 Hz), 7.70 (bs, 1H)

### Synthesis Example 22

### Synthesis of N-methyl-3-(2′,6′-dichlorophenyl)benzamide (compound No. 1-30)

The objective compound having a melting point of 174.8° C. was obtained in the same manner as in SYNTHESIS EXAMPLE 4 except that 2,6-dichlrobenzene boronic acid was used-instead of 4-chloro-2,6-dimethylbenzene boronic acid. Further, NMR of this.compound was as follows.

¹H-NMR δ (ppm) 3.01 (d, 3H; J=4.8 Hz), 6.25 (bs, 1H), 7.24 (t, 1H; J=7.5 Hz), 7.37-7.42 (m, 1H), 7.52 (t, 1H; J=7.5 Hz), 7.65 (s, 1H), 7.83 (d, 1H; J=7.5 Hz)

### Synthesis Example 23

### Synthesis of N-methy1-3-(2′,6′-dichloro-3′-nitrophenyl)benzamide (compound No. 1-109)

0.56 g of N-methyl-3-(2′,6′-dichlorophenyl)benzamide (compound No. 1-30) obtained in SYNTHESIS EXAMPLE 22 was dissolved in 5 ml of concentrated sulfuric acid. While stirring, 0.18 g of 70% nitric acid (d 1.42) was slowly dropwise added at temperature of from 0 to 2° C. The mixture was then gradually warmed and stirred at room temperature for 2 hours. The reaction solution was poured into 30 g of ice with stirring, and 50 ml of ethyl acetate was added, followed by stirring for a while. The organic layer was dried over anhydrous sodium sulfate, and the solvent was distilled off under reduced pressure. The residue was purified by silica gel (Silica gel 60N; spherical and neutral, manufactured by Kanto Kagaku) column chromatography to obtain 0.61 g of the objective compound in an amorphous solid state. Further, NMR of this compound was as follows.

¹H-NMR δ (ppm) 2.93 (d, 3H; J=4.5 Hz), 6.94 (d, 1H; J=4.5 Hz), 7.31 (d, 1H; J=7.8 Hz), 7.49 (t, 1H; J=7.8 Hz), 7.51 (d, 1H; J=8.7 Hz), 7.66 (s, 1H), 7.73 (d, 1H; J=8.7 Hz), 7.85 (d, 1H; J=7.8 Hz)

### Synthesis Example 24

### Synthesis of N-methyl-3-(2′,6′-dichloro-3′-aminophenyl)benzamide (compound No. 1-108)

2.2 g of reduced iron was added over a period of 15 minutes dividedly in several times with stirring at a temperature of from 50 to 57° C. to a solution of 3.3 g of N-methyl-3-(2′,6′-dichloro-3,′-nitrophenyl)benzamide (compound No. 1-109) obtained in SYNTHESIS EXAMPLE 23 in 25 ml of acetic acid, followed by stirring under heating at 60° C. for 1 hour.

After cooling to 40° C., 50 ml of ethyl acetate was added to the system, followed by stirring, and the filtrate obtained by celite filtration was washed with a dilute sodium hydrogen carbonate aqueous solution, and then with a saturated sodium chloride aqueous solution. The organic layer was dried over anhydrous sodium sulfate, and the solvent was distilled off under reduced pressure. The residue was purified by silica gel (Silica gel 60N; spherical and neutral, manufactured by Kanto Kagaku) column chromatography (developing solvent of n-hexane:ethyl acetate=1:1, containing 0.3% of triethylamine) to obtain 2.5 g of the objective compound having a melting point of 64.1° C. Further, NMR of this compound was as follows.

¹H-NMR δ (ppm) 2.92 (d, 3H; J=4.5 Hz) 6.74 (d, 1H; J=8.7 Hz), 7.02 (bs, 1H), 7.09 (d, 1H; J=8.7 Hz), 7.28 (d, 1H; J=7.5 Hz), 7.43 (t, 1H; J=7.5 Hz), 7.61 (s, 1H), 7.81 (d, 1H; J=7.5 Hz)

### Synthesis Example 25

### Synthesis of N-methyl-3-(2′,6′-dichloro-3′-bromophenyl)benzamide (compound No. 1-82)

0.86 g of t-butyl nitrite (90%) was added at 0° C. to a solution having 1.34 g of copper(II) bromide dissolved in 40 ml of acetonitrile. A solution having 1.5 g N-methyl-3-(2′,6′-dichloro-3′-aminophenyl)benzamide (compound No. 1-108) obtained in SYNTHESIS EXAMPLE 24 in 20 ml of acetonitrile was dropwise added thereto with stirring at a temperature of from −5° C. to 0° C. over a period of 10 minutes. Then, the mixture was stirred at room temperature for 2.5 hours. 10 ml of cold water and 50 ml of ethyl acetate were added, the organic layer was separated and dried over anhydrous sodium sulfate, and then the solvent was distilled off under reduced pressure. The residue was purified by silica gel (Silica gel 60N; spherical and neutral, manufactured by Kanto Kagaku) column chromatography (developing solvent of n-hexane:ethyl acetate=2:1 to 1:1) to obtain 145 g of the objective compound having a melting-point of 158.0° C. Further, NMR of this compound was as follows.

¹H-NMR δ (ppm) 3.02 (d, 3H; J=4.8 Hz), 6.21 (bs, 1H), 7.28 (d, 1H; J=8.7 Hz), 7.35 (d, 1H; J=7.5 Hz), 7.54 (t, 1H; J=7.5 Hz), 7.59 (d, 1H; J=8.7 Hz), 7.61 (s, 1H), 7.83 (d, 1H; J=7.5 Hz)

### Synthesis Example 26

### Synthesis of N-methyl-3-(2′,3′,6′-trichlorophenyl)benzamide (compound No. 1-72)

The objective compound having a melting point of 135.3° C. was obtained in the same manner as in SYNTHESIS EXAMPLE 25 except that copper(II) chloride (anhydrous) was used instead of copper(II) bromide. Further, NMR of this compound was as follows.

¹H-NMR δ (ppm) 2.95 (d, 3H; J=4.5 Hz), 6.71 (bs, 1H), 7.30 (d, 1H; J=7.5 Hz), 7.31 (d, 1H; J=8.7 Hz), 7.40 (d, 1H; J=8.7 Hz), 7.50 (d, 1H; J=7.5 Hz), 7.64 (s, 1H), 7.83 (d, 1H; J=7.5 Hz)

### Synthesis Example 27

### Synthesis of N-methyl-N-propargyl-3-(2′,3′,6′-trichlorophenyl)benzamide (compound No. 1-75)

0.14 g of 60% sodium hydride was added under cooling with ice to a solution of 0.2 g of N-methyl-3-(2′,3′,6′-trichlorophenyl)benzamide (compound No. 1-72) obtained in SYNTHESIS EXAMPLE 26 in 20 ml of anhydrous tetrahydrofuran, followed by stirring at same temperature for 20 minutes. Then, 0.19 ml of propargyl bromide was added under cooling with ice, followed by stirring at room temperature for 3 hours. Cold water was added to the reaction system, and extraction with 50 ml of ethyl acetate was carried out twice. The organic layers were put together and washed with a saturated sodium chloride aqueous solution. Then, the organic layer was dried over anhydrous sodium sulfate, and the solvent was distilled off under reduced pressure. The residue was purified by silica gel (Silica gel 60N; spherical and neutral, manufactured by Kanto Kagaku) column chromatography (developing solvent of n-hexane:ethyl acetate=2:1) to obtain 0.18 g of the objective compound in an amorphous solid state. Further, NMR of this compound was as follows.

¹H-NMR δ (pprm) 2.29 (bs, 1H), 3.10 (bs, 3H), 4.05 & 4.36 (bs each, 2H), 7.23-7.57 (m, 6H)

### Synthesis Example 28

### Synthesis of N-methyl-3-(2′,6′-dimethyl-4′-methoxyphenyl)benzamide (compound No. 1-65)

(1) 0.35 g of tetrakistriphenylphosphine palladium was added under cooling with ice to a solution having 2.2 g of 3,5-dimethyl-4-bromoanisole dissolved it a mixed solvent of 50 ml of toluene and 8 ml of ethanol, followed by stirring for 20 minutes. 1.8 g of 3-caboxyphenyl boronic acid and 12 ml of a 2M sodium carbonate aqueous solution were added thereto, and the reaction system was flushed with nitrogen, followed by reflux under heating for 22 hours.

After cooling, 50 ml of cold water was added, 100 ml of ethyl acetate was added, and then the precipitate was filtered off. Then, the organic layer was obtained from the filtrate. The water layer was again extracted with 50 ml of ethyl acetate. The organic layers were put together and dried over anhydrous sodium sulfate, and then the solvent was distilled off under reduced pressure. The residue was purified by silica gel (Silica gel 60N; spherical and neutral, manufactured by Kanto Kagaku) column chromatography (developing solvent of n-hexane:ethyl acetate=1:1) to obtain 0.52 g of 3-(2′,6′-dimethyl-4′-methoxyphenyl)benzoic acid as white crystals. Further, NMR of this compound was as follows.

¹H-NMR δ (ppm) 2.01 (s, 6H), 3.83 (s, 3H), 6.68 (s, 2H), 7.40 (d, 1H; J=7.5 Hz), 7.53 (t, 1H; J=7.5 Hz), 7.91 (s, 1H), 8.08 (d, 1H; J=7.5 Hz)

(2) 0.26 g of 3-(2′,6′-dimethyl-4′-methoxyphenyl)benzoic acid obtained in (1) was dissolved in 5 ml of 1,2-dichloroethane, and 0.22 ml of thionyl chloride and 2 drops of N,N-dimethyIformamide were added at room temperature, followed by stirring for 2 hours under reflux under heating. After cooling, 30 ml of toluene was added to the reaction solution, followed by concentration under reduced pressure. 30 ml of toluene was again added to the residual oil, followed by concentration to obtain 0.34 g of crude 3-(2′,6′-dimethyl-4′-methoxyphenyl)benzoic chloride.

A mixed solution of 0.4 g of a methanol solution of 40% methylamine and 3 ml of anhydrous tetrahydrofuran:, was dropwise added to a solution of the 0.34 g crude 3-(2′,6′-dimethyl-4′-methoxyphenyl)benzoic chloride obtained in (1) in 7 ml of anhydrous tetrahydrofuran, followedby stirring at room temperature for 4 hours. 10 ml of ice water and 20 ml of ethyl acetate were added to the reaction solution, followed by stirring for a while. Then, liquid separation was carried out. The obtained organic layer was washed with a saturated sodium chloride aqueous solution and dried over anhydrous sodium sulfate, and then the solvent was distilled off under reduced pressure. The obtained solid was pulverized in a mixed solvent of 10 ml of n-hexane and 2 ml of diethyl ether, filtered and dried to obtain 0.18 g of the objective compound having a melting point of 139.6° C. Further, NMR of this compound was as follows.

¹H-NMR δ (ppm) 1.99 (s, 6H), 3.01 (d, 3H; J=4.5 Hz), 3.82 (s, 3H), 6.19 (bs, 1H), 6.66 (s, 2H), 7.27 (d, 1H; J=7.8 Hz), 7.47 (t, 1H; J=7.8 Hz), 7.52 (s, 1H), 7.74 (d, 1H; J=7.8 Hz)

Here, compounds represented by the formula (I) which may be produced in accordance with the above-mentioned processes 1 to 3 and SYNTHESIS EXAMPLES 1 to 28 are shown in Tables 1 and 2. Further, in Tables, Me represents methyl, Et represents ethyl, n-Pr represents normal propyl, i-Pr represents isopropyl, n-Bu represents normal butyl, c-Pr represents cyclopropyl, t-Bu represents tertiary butyl, i-Bu represents isobutyl, and — represents a single bond.

Further, the position for substitution of Z in Table 2 is represented′by a numeral of from 1 to 6 in the formula in Table 2. In the column for the physical properties, mp (melting point) is one measured by an automatic melting point measuring apparatus (METTLER FP62, manufactured by Mettler Toldo K.K.).

TABLE 1

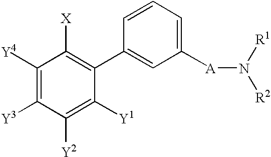

| | | | | | | | | | Physical |
|---|---|---|---|---|---|---|---|---|---|
| No. | X | Y¹ | Y² | Y³ | Y⁴ | A | R¹ | R² | property |
| 1-1 | Me | Me | H | Me | H | —CO— | Et | Et | Oily |
| | | | | | | | | | substance |
| 1-2 | Me | Me | H | Me | H | —CO— | Me | Me | Oily |
| | | | | | | | | | substance |
| 1-3 | Me | Me | H | Me | H | —CO— | Me | Et | Amorphous |
| | | | | | | | | | solid |
| 1-4 | Me | Me | H | Me | H | —CO— | Me | n-Pr | Oily |
| | | | | | | | | | substance |
| 1-5 | Me | Me | H | Me | H | —CO— | H | n-Bu | mp 103.3° C. |
| 1-6 | Me | Me | H | Me | H | —CO— | Me | n-Heptyl | Oily |
| | | | | | | | | | substance |
| 1-7 | Me | Me | H | Me | H | —CO— | Me | CH₂-c-Pr | Oily |
| | | | | | | | | | substance |
| 1-8 | Me | Me | H | Me | H | —CO— | Me | Phenethyl | |
| 1-9 | Me | Me | H | Me | H | —CO— | Me | Allyl | Oily |
| | | | | | | | | | substance |
| 1-10 | Me | Me | H | Me | H | —CO— | Me | 3-Me-2- | Oily |
| | | | | | | | | butenyl | substance |
| 1-11 | Me | Me | H | Me | H | —CO— | Me | 3-Br-allyl | Oily |
| | | | | | | | | | substance |
| 1-12 | Me | Me | H | Me | H | —CH₂— | Et | Et | Oily |
| | | | | | | | | | substance |
| 1-13 | Me | Me | H | Me | H | —CO— | Me | Propargyl | Amorphous |
| | | | | | | | | | solid |
| 1-14 | Me | Me | H | Cl | H | —CO— | Me | Propargyl | Amorphous |
| | | | | | | | | | solid |
| 1-15 | Me | Me | H | t-Bu | H | —CO— | Me | Propargyl | mp 99.3° C. |
| 1-16 | Me | Me | H | Me | H | —CO— | H | Propargyl | mp 118.5° C. |
| 1-17 | Me | Me | H | Me | H | —CO— | Me | 2-butynyl | Oily |
| | | | | | | | | | substance |
| 1-18 | Me | Me | H | Me | H | —CO— | Me | CH₂CN | Oily |
| | | | | | | | | | substance |
| 1-19 | Me | Me | H | Me | H | —CO— | H | CH₂CN | Amorphous |
| | | | | | | | | | solid |
| 1-20 | Me | Me | H | Me | H | —CO— | Me | Phenyl | mp 141.9° C. |
| 1-21 | Me | Me | H | Me | H | —CO— | Me | Benzyl | Oily |
| | | | | | | | | | substance |
| 1-22 | Me | Me | H | Me | H | —CO— | Me | H | mp 142.9° C. |
| 1-23 | Me | Me | H | Cl | H | —CO— | Me | H | mp 137.1° C. |
| 1-24 | Me | Me | H | t-Bu | H | —CO— | Me | H | mp 192.3° C. |
| 1-25 | Me | Me | H | Me | H | —CO— | H | Et | mp 136.5° C. |
| 1-26 | Me | Me | H | SMe | H | —CO— | Me | H | |
| 1-27 | Me | Me | H | Me | H | —CH₂— | Me | H | Oily |
| | | | | | | | | | substance |
| 1-28 | Me | Me | H | Me | H | —CH₂— | Me | Propargyl | Oily |
| | | | | | | | | | substance |
| 1-29 | Me | Me | H | Me | H | —CO— | Me | i-Bu | Oily |
| | | | | | | | | | substance |
| 1-30 | Cl | Cl | H | H | H | —CO— | Me | H | mp 174.8° C. |
| 1-31 | Cl | Cl | H | H | H | —CO— | Me | Propargyl | Amorphous |
| | | | | | | | | | solid |
| 1-32 | Cl | Cl | H | SMe | H | —CO— | Me | H | |
| 1-33 | Cl | Cl | H | SMe | H | —CO— | Me | allyl | |
| 1-34 | Cl | Cl | H | SMe | H | —CO— | Me | Propargyl | |
| 1-35 | Cl | Cl | H | SO₂Me | H | —CO— | Me | H | |
| 1-36 | OMe | OMe | H | H | H | —CO— | Me | H | Oily |
| | | | | | | | | | substance |
| 1-37 | F | F | H | H | H | —CO— | Me | H | Oily |
| | | | | | | | | | substance |
| 1-38 | Cl | Cl | H | SO₂Me | H | —CO— | Me | H | |
| 1-39 | Cl | Cl | H | SO₂Me | H | —CO— | Me | Propargyl | |
| 1-40 | Me | Me | H | Me | H | —CH2— | H | COMe | mp 114.5° C. |
| 1-41 | Me | Me | H | Me | H | —CH₂— | Me | COMe | Oily |
| | | | | | | | | | substance |
| 1-42 | Me | Me | H | Me | H | —CH₂— | H | CN | Oily |
| | | | | | | | | | substance |
| 1-43 | Me | Me | H | Me | H | — | H | CHO | mp >300° C. |
| 1-44 | Me | Me | H | Me | H | — | H | COMe | mp 173.8° C. |
| 1-45 | Me | Me | H | Me | H | — | Me | COMe | Oily |
| | | | | | | | | | substance |
| 1-46 | Me | Me | H | Me | H | — | H | COEt | |
| 1-47 | Me | Me | H | Me | H | — | Me | COEt | |
| 1-48 | Me | Me | H | Me | H | — | H | CO-i-Pr | |
| 1-49 | Me | Me | H | Me | H | — | H | CO-n-Pr | mp 136.6° C. |
| 1-50 | Cl | Cl | H | SMe | H | — | H | COMe | mp 158.6° C. |
| 1-51 | Me | Me | H | SMe | H | — | H | COMe | |
| 1-52 | Me | Me | H | OMe | H | — | H | COMe | |
| 1-53 | Me | Me | H | Cl | H | — | H | COMe | |
| 1-54 | OMe | OMe | H | H | H | — | H | COMe | |
| 1-55 | Me | Me | H | OCH₂OMe | H | — | H | COMe | Oily |
| | | | | | | | | | substance |
| 1-56 | Me | Me | H | O(5-CF₃- | H | — | H | COMe | mp 174.7° C. |
| | | | | 2- | | | | | |
| | | | | pyridyl) | | | | | |
| 1-57 | Me | Me | H | O(5-CF₃- | H | — | H | H | mp 200.3° C. |
| | | | | 2- | | | | | |
| | | | | pyridyl) | | | | | |
| 1-58 | Me | Me | H | Me | H | — | H | acryloyl | mp 114.1° C. |
| 1-59 | Me | Me | H | Me | H | — | H | NMe₂ | Amorphous |
| | | | | | | | | | solid |
| 1-60 | Me | Me | H | Me | H | — | H | N═CH₂ | Amorphous |
| | | | | | | | | | solid |
| 1-61 | Me | Me | H | Me | H | — | H | NHCOMe | |
| 1-62 | Me | Me | H | Me | H | —CO— | H | CONHMe | mp. 207.0° C. |
| 1-63 | Me | Me | H | Me | H | —CO— | CONHMe | CONHMe | mp 93.8° C. |
| 1-64 | Me | Me | H | Me | H | —CO— | Me | CH₂SMe | Oily |
| | | | | | | | | | substance |
| 1-65 | Me | Me | H | OMe | H | —CO— | H | Me | mp 139.6° C. |
| 1-66 | Cl | Cl | H | Cl | H | —CO— | H | Me | mp 173.0° C. |
| 1-67 | Cl | H | Cl | Cl | H | —CO— | H | Me | mp 169.3° C. |
| 1-68 | CF₃ | Cl | F | H | H | —CO— | H | Me | mp 158.9° C. |
| 1-69 | F | CF₃ | H | H | H | —CO— | H | Me | mp 158.7° C. |
| 1-70 | F | H | H | CF₃ | H | —CO— | H | Me | Amorphous |
| | | | | | | | | | solid |
| 1-71 | F | Cl | H | H | H | —CO— | H | Me | Amorphous |
| | | | | | | | | | solid |
| 1-72 | Cl | Cl | Cl | H | H | —CO— | H | Me | mp 135.3° C. |
| 1-73 | Cl | Cl | Cl | H | H | —CO— | H | Et | |
| 1-74 | Cl | F | F | H | H | —CO— | H | Me | Amorphous |
| | | | | | | | | | solid |
| 1-75 | Cl | Cl | Cl | H | H | —CO— | Me | Propargyl | Amorphous |
| | | | | | | | | | solid |
| 1-76 | Cl | Cl | Cl | H | H | —CO— | Me | Et | Oily |
| | | | | | | | | | substance |
| 1-77 | Cl | Cl | Cl | H | H | —CO— | Me | 2- | Oily |
| | | | | | | | | Butynyl | substance |
| 1-78 | Cl | Cl | Cl | H | H | —CO— | Me | 6-CF₃-3- | Amorphous |
| | | | | | | | | pyridylm | solid |
| | | | | | | | | ethyl | |
| 1-79 | Cl | Cl | Cl | H | H | —CO— | Me | 3-Me-2- | Oily |
| | | | | | | | | butenyl | substance |
| 1-80 | Cl | Cl | Cl | H | H | —CO— | Me | 2-Cl- | Amorphous |
| | | | | | | | | allyl | solid |
| 1-81 | Cl | Cl | F | H | H | —CO— | H | Me | |
| 1-82 | Cl | Cl | Br | H | H | —CO— | H | Me | mp 158.0° C. |
| 1-83 | F | Cl | Cl | H | H | —CO— | H | Me | mp 90.0° C. |
| 1-84 | Cl | F | Cl | H | H | —CO— | H | Me | mp 143.0° C. |
| 1-85 | Cl | H | H | Cl | H | —CO— | H | Me | Oily |
| | | | | | | | | | substance |
| 1-86 | Cl | Cl | Me | H | H | —CO— | H | Me | mp 118.8° C. |
| 1-87 | Cl | Cl | Me | H | H | —CO— | H | 3-Pyridyl | |
| 1-88 | Cl | Cl | Me | H | H | —CO— | Me | Propargyl | Amorphous |
| | | | | | | | | | solid |
| 1-89 | Cl | Cl | Me | H | H | —CO— | Me | Me | Oily |
| | | | | | | | | | substance |
| 1-90 | Cl | Cl | Me | H | H | —CO— | Me | Et | Oily |
| | | | | | | | | | substance |
| 1-91 | Cl | Cl | Me | H | H | —CO— | Me | Methallyl | Oily |
| | | | | | | | | | substance |
| 1-92 | Cl | Cl | Me | H | H | —CO— | Et | Et | Oily |
| | | | | | | | | | substance |
| 1-93 | Cl | Cl | Me | H | H | —CO— | H | Et | Oily |
| | | | | | | | | | substance |
| 1-94 | Cl | Me | Me | H | H | —CO— | H | Me | |
| 1-95 | Me | Cl | Me | H | H | —CO— | H | Me | |
| 1-96 | Me | Me | Cl | H | H | —CO— | H | Me | |
| 1-97 | Cl | Me | Cl | H | H | —CO— | H | Me | |
| 1-98 | Me | Cl | Cl | H | H | —CO— | H | Me | |
| 1-99 | F | Cl | Me | H | H | —CO— | H | Me | mp 117.3° C. |
| 1-100 | F | Cl | Me | H | H | —CO— | Me | Propargyl | Oily |
| | | | | | | | | | substance |
| 1-101 | Cl | Cl | OMe | H | H | —CO— | H | Me | mp 54.2° C. |
| 1-102 | Cl | Cl | SMe | H | H | —CO— | H | Me | |
| 1-103 | Cl | Cl | SOMe | H | H | —CO— | H | Me | |
| 1-104 | Cl | Cl | SO₂Me | H | H | —CO— | H | Me | |
| 1-105 | Cl | Cl | NHMe | H | H | —CO— | H | Me | Amorphous |
| | | | | | | | | | solid |
| 1-106 | Cl | Cl | NMe₂ | H | H | —CO— | H | Me | |
| 1-107 | Cl | Cl | OH | H | H | —CO— | H | Me | mp 189.7° C. |
| 1-108 | Cl | Cl | NH₂ | H | H | —CO— | H | Me | mp 64.1° C. |
| 1-109 | Cl | Cl | NO₂ | H | H | —CO— | H | Me | Amorphous |
| | | | | | | | | | solid |
| 1-110 | Cl | Cl | CONHMe | H | H | —CO— | H | Me | |
| 1-111 | Cl | Cl | CONMe₂ | H | H | —CO— | H | Me | |
| 1-112 | Cl | F | Me | H | H | —CO— | H | Me | mp 88.9° C. |
| 1-113 | Cl | F | Me | H | H | —CO— | Me | Propargyl | Oily |
| | | | | | | | | | substance |
| 1-114 | Cl | Cl | CH₂OMe | H | H | —CO— | Me | H | |
| 1-115 | Cl | Cl | CH₂SMe | H | H | —CO— | Me | H | |
| 1-116 | Cl | Cl | C═NMe | H | H | —CO— | Me | H | |
| 1-117 | Cl | Cl | C═NOMe | H | H | —CO— | Me | H | |
| 1-118 | Cl | Cl | 1,3- | H | H | —CO— | Me | H | |
| | | | | Dioxolan- | | | | | |
| | | 2-yl | | | | | | | |
| 1-119 | Cl | Cl | 5-CF₃-pyridin- | H | H | —CO— | Me | H | |
| | | | 2-yl | | | | | | |
| 1-120 | Cl | Cl | CF₃ | H | H | —CO— | H | Me | mp 126.1° C. |
| 1-121 | Cl | Cl | CF₃ | H | H | —CO— | Me | Me | Oily |
| | | | | | | | | | substance |
| 1-122 | Cl | Cl | CF₃ | H | H | —CO— | Me | Et | Oily |
| | | | | | | | | | substance |
| 1-123 | Cl | Cl | CF₃ | H | H | —CO— | Me | Propargyl | Amorphous |
| | | | | | | | | | solid |
| 1-124 | Cl | Cl | CF₃ | H | H | —CO— | Me | Methallyl | Oily |
| | | | | | | | | | substance |
| 1-125 | Cl | Cl | CF₃ | H | H | —CO— | Me | 5-CF₃-2- | |
| | | | | | | | | pyridyl | |
| 1-126 | Cl | Cl | CF₃ | H | H | —CO— | Et | Et | Oily |
| | | | | | | | | | substance |
| 1-127 | Cl | Cl | CF₃ | H | H | —CO— | H | Et | mp 137.0° C. |
| 1-128 | Cl | Cl | CH₂F | H | H | —CO— | H | Me | |
| 1-129 | Cl | Cl | CH₂Cl | H | H | —CO— | H | Me | |
| 1-130 | Cl | Cl | CH₂Br | H | H | —CO— | H | Me | |
| 1-131 | Cl | Cl | CHO | H | H | —CO— | H | Me | |
| 1-132 | Cl | Cl | CHF₂ | H | H | —CO— | H | Me | |
| 1-133 | OMe | Cl | Cl | H | H | —CO— | H | Me | |
| 1-134 | F | F | Cl | H | H | —CO— | H | Me | |
| 1-135 | F | F | H | H | H | —CO— | H | Me | Oily |
| | | | | | | | | | substance |
| 1-136 | OMe | OMe | H | H | H | —CO— | H | Me | Oily |
| | | | | | | | | | substance |
| 1-137 | OMe | H | H | OMe | H | —CO— | H | Me | Oily |
| | | | | | | | | | substance |
| 1-138 | Cl | H | OMe | H | H | —CO— | H | Me | Oily |
| | | | | | | | | | substance |
| 1-139 | Cl | H | Cl | H | H | —CO— | H | Me | mp 141.0° C. |
| 1-140 | Cl | H | Cl | H | Cl | —CO— | H | Me | |
| 1-141 | Me | Me | H | H | H | —CO— | Me | H | mp 193.6° C. |
| 1-142 | Me | Me | H | Me | H | —CS— | H | Me | mp 62.5° C. |
| 1-143 | Cl | Cl | H | H | H | —CS— | H | Me | |
| 1-144 | Cl | Cl | Cl | H | H | —CS— | H | Me | |
| 1-145 | Cl | Cl | Cl | H | H | —CS— | Me | Propargyl | |
| 1-146 | Cl | Cl | CF₃ | H | H | —CS— | H | Me | |
| 1-147 | Cl | Cl | Me | H | H | —CS— | H | Me | |
| 1-148 | Me | Me | H | Me | H | —CO— | Me | Phenethyl | |
| 1-149 | Cl | Cl | H | H | H | —CO— | Me | Et | Oily |
| | | | | | | | | | substance |
| 1-150 | Cl | Cl | H | H | H | —CO— | Me | 2-F-ethyl | Oily |
| | | | | | | | | | substance |
| 1-151 | Cl | Cl | H | H | H | —CO— | Me | allyl | Oily |
| | | | | | | | | | substance |
| 1-152 | Cl | Cl | H | H | H | —CO— | Me | 3-Me-2- | Oily |
| | | | | | | | | butenyl | substance |
| 1-153 | OMe | H | H | OMe | H | —CO— | Me | H | Oily |
| | | | | | | | | | substance |
| 1-154 | Cl | H | OMe | H | H | —CO— | Me | H | Oily |
| | | | | | | | | | substance |
| 1-155 | Cl | H | H | H | Cl | —CO— | Me | H | |
| 1-156 | Cl | Cl | H | H | H | —CO— | Me | 2-Butynyl | Amorphous |
| | | | | | | | | | solid |
| 1-157 | Cl | Cl | H | H | H | —CO— | Et | Et | Amorphous |
| | | | | | | | | | solid |
| 1-158 | Cl | Cl | H | H | H | —CO— | Me | Geranyl | Oily |
| | | | | | | | | | substance |
| 1-159 | Cl | Cl | H | H | H | —CO— | Me | Methallyl | Oily |
| | | | | | | | | | substance |
| 1-160 | Cl | Cl | H | H | H | —CO— | H | Benzyl | mp 139.7° C. |
| 1-161 | Cl | Cl | H | H | H | —CO— | H | Phenethyl | Amorphous |
| | | | | | | | | | solid |
| 1-162 | Cl | Cl | H | H | H | —CO— | H | 2-Cl-benzyl | mp 121.3° C. |
| 1-163 | Cl | Cl | H | H | H | —CO— | H | 3-Cl-benzyl | Amorphous |
| | | | | | | | | | solid |
| 1-164 | Cl | Cl | H | H | H | —CO— | H | 2-Pyridyl- | Amorphous |
| | | | | | | | | methyl | solid |
| 1-165 | Cl | Cl | H | H | H | —CO— | H | 3-Pyridyl- | |
| | | | | | | | | methyl | |
| 1-166 | Cl | Cl | H | H | H | —CO— | H | 4-Pyridyl- | Amorphous |
| | | | | | | | | methyl | solid |
| 1-167 | Cl | Cl | H | H | H | —CO— | H | 6-Cl-3- | mp 121.0° C. |
| | | | | | | | | pyridyl- | |
| | | | | | | | | methyl | |
| 1-168 | Cl | Cl | H | H | H | —CO— | H | 2-Furanyl- | mp 146.0° C. |
| | | | | | | | | mehtyl | |
| 1-169 | Cl | Cl | H | H | H | —CO— | H | Propargyl | Amorphous |
| | | | | | | | | | solid |
| 1-170 | Cl | Cl | H | H | H | —CO— | H | 2-Methoxy- | mp 52.0° C. |
| | | | | | | | | ethyl | |
| 1-171 | Cl | Cl | H | H | H | —CO— | H | 2-Cyano- | mp 113.0° C. |
| | | | | | | | | ethyl | |
| 1-172 | Cl | Cl | H | H | H | —CO— | H | Cyclopropyl | mp 162.6° C. |
| 1-173 | Cl | Cl | H | H | H | —CO— | Me | Cyclopropyl | Oily |
| | | | | | | | | | substance |
| 1-174 | Cl | Cl | H | H | H | —CO— | Me | 4-F-benzyl | Oily |
| | | | | | | | | | substance |
| 1-175 | Cl | Cl | H | H | H | —CO— | Me | 4- | Amorphous |
| | | | | | | | | Cyanobenzyl | solid |
| 1-176 | Cl | Cl | H | H | H | —CO— | Me | 3-F-benzyl | Oily |
| | | | | | | | | | substance |
| 1-177 | Cl | Cl | H | H | H | —CO— | Me | 4-CF₃O- | Oily |
| | | | | | | | | | substance |
| 1-178 | Cl | Cl | H | H | H | —CO— | Me | 4-CF₃-benzyl | Amorphous |
| | | | | | | | | | solid |
| 1-179 | Cl | Cl | H | H | H | —CO— | Me | 4-Cl-benzyl | Amorphous |
| | | | | | | | | | solid |
| 1-180 | Cl | Cl | H | H | H | —CO— | Me | 2-Butenyl | Oily |
| | | | | | | | | | substance |
| 1-181 | Cl | Cl | H | H | H | —CO— | Me | 2-Br-allyl | Oily |
| | | | | | | | | | substance |
| 1-182 | Cl | Cl | H | H | H | —CO— | Me | 3-Cl-2- | Amorphous |
| | | | | | | | | butenyl | solid |
| 1-183 | Cl | Cl | H | H | H | —CO— | Me | 3,4-F₂- | Amorphous |
| | | | | | | | | benzyl | solid |
| 1-184 | Cl | Cl | H | H | H | —CO— | Me | 4-Me-benzyl | Amorphous |
| | | | | | | | | | solid |
| 1-185 | CF₃ | F | H | H | H | —CO— | Me | 3-Me-2 | Oily |
| | | | | | | | | butenyl | substance |
| 1-186 | CF₃ | F | H | H | H | —CO— | Me | 2-Butynyl | Oily |
| | | | | | | | | | substance |
| 1-187 | CF₃ | F | H | H | H | —CO— | Me | Benzyl | Oily |
| | | | | | | | | | substance |
| 1-188 | Cl | F | H | H | H | —CO— | Me | 3-Me-2- | Oily |
| | | | | | | | | butenyl | substance |
| 1-189 | Cl | F | H | H | H | —CO— | Me | 2-Butynyl | Oily |
| | | | | | | | | | substance |
| 1-190 | Cl | F | H | H | H | —CO— | Me | Benzyl | Oily |
| | | | | | | | | | substance |
| 1-191 | Cl | Cl | F | H | H | —CO— | Me | 3-Me-2- | Oily |
| | | | | | | | | butenyl | substance |
| 1-192 | Cl | F | F | H | H | —CO— | Me | 3-Me-2- | Oily |
| | | | | | | | | butenyl | substance |
| 1-193 | Cl | F | F | H | H | —CO— | Me | Propargyl | Oily |
| | | | | | | | | | substance |
| 1-194 | Cl | F | F | H | H | —CO— | Me | Benzyl | Amorphous |
| | | | | | | | | | solid |
| 1-195 | Cl | F | F | H | H | —CO— | Me | 6-Cl-3- | Amorphous |
| | | | | | | | | pyridyl- | solid |
| | | | | | | | | methyl | |
| 1-196 | Cl | Cl | Cl | H | Cl | —CO— | Me | H | mp 195.5° C. |
| 1-197 | F | F | F | F | F | —CO— | Me | H | |
| 1-198 | Me | Me | H | Me | H | — | H | COCF₃ | mp 70.7° C. |
| 1-199 | Cl | Cl | H | SOMe | H | — | H | COMe | mp 213.0° C. |
| 1-200 | Cl | Cl | H | H | H | — | H | COMe | mp 195.2° C. |
| 1-201 | Me | Me | H | Me | H | — | H | Me | |
| 1-202 | Me | Me | H | Me | H | — | H | H | mp 121.5° C. |
| 1-203 | Me | Me | H | OH | H | — | H | COMe | mp 173.2° C. |
| 1-204 | Cl | Cl | H | Br | H | — | H | H | mp 107.0° C. |
| 1-205 | Cl | Cl | H | Br | H | — | H | COMe | mp 200.6° C. |
| 1-206 | Cl | Cl | H | Br | H | — | H | COCF₃ | mp 140.0° C. |
| 1-207 | Cl | Cl | H | SMe | H | — | H | H | Oily |
| | | | | | | | | | substance |
| 1-208 | Cl | Cl | H | H | H | — | H | COCF₃ | mp 112.6° C. |
| 1-209 | Cl | Cl | H | H | H | — | H | CHO | mp 114.0° C. |
| 1-210 | Cl | Cl | H | CF₃ | H | — | H | H | Amorphous |
| | | | | | | | | | solid |
| 1-211 | Cl | H | H | CF₃ | H | — | H | H | Amorphous |
| | | | | | | | | | solid |
| 1-212 | Cl | Cl | H | H | H | — | CHO | allyl | Amorphous |
| | | | | | | | | | solid |
| 1-213 | Cl | Cl | H | H | H | — | CHO | 4-F-benzyl | Amorphous |
| | | | | | | | | | solid |
| 1-214 | Cl | Cl | H | H | H | — | CHO | 6-Cl-3- | Amorphous |
| | | | | | | | | pyridyl- | solid |
| | | | | | | | | methyl | |
| 1-215 | Cl | Cl | H | H | H | — | CHO | 4- | |
| | | | | | | | | Thiazolyl- | |
| | | | | | | | | methyl | |
| 1-216 | Cl | Cl | H | H | H | — | CHO | Propargyl | Amorphous |
| | | | | | | | | | solid |
| 1-217 | Cl | Cl | H | H | H | — | CHO | Me | mp 120.3° C. |
| 1-218 | Cl | Cl | Cl | H | H | — | H | H | Oily |
| | | | | | | | | | substance |
| 1-219 | Cl | Cl | Cl | H | H | — | H | CHO | |
| 1-220 | Cl | Cl | Cl | H | H | — | H | COMe | mp 159.8° C. |
| 1-221 | Cl | Cl | Me | H | H | — | H | H | |
| 1-222 | Cl | Cl | Me | H | H | — | H | CHO | |
| 1-223 | Cl | Cl | CF₃ | H | H | — | H | H | |
| 1-224 | Cl | Cl | CF₃ | H | H | — | H | CHO | |
| 1-225 | Cl | Cl | CF₃ | H | H | — | H | COCF3 | |
| 1-226 | Cl | Cl | CF₃ | H | H | — | H | COMe | |
| 1-227 | Cl | H | H | Cl | H | —CO— | Me | 6-Cl-3- | Amorphous |
| | | | | | | | | pyridyl- | solid |
| | | | | | | | | methyl | |
| 1-228 | Cl | Cl | H | H | H | —CO— | Me | 2-Thienyl | Amorphous |
| | | | | | | | | | solid |
| 1-229 | Cl | Cl | H | H | H | —CO— | H | 2-Thienyl | Amorphous |
| | | | | | | | | | solid |
| 1-230 | Cl | Cl | H | H | H | —CO— | Me | 3-Thienyl | Amorphous |
| | | | | | | | | | solid |
| 1-231 | Cl | O(5-CF₃- | H | H | H | — | H | CHO | Amorphous |
| | | 2- | | | | | | | solid |
| | | pyridyl) | | | | | | | |
| 1-232 | Cl | O(5-CF₃- | H | H | H | — | H | COMe | mp 103.0° C. |
| | | 2- | | | | | | | |
| | | pyridyl) | | | | | | | |
| 1-233 | Cl | O(5-CF₃- | H | H | H | — | H | H | Amorphous |
| | | 2- | | | | | | | solid |
| | | pyridyl) | | | | | | | |
| 1-234 | Cl | Cl | F | H | H | —CO— | Me | 2-Butynyl | |
| 1-235 | Cl | Cl | F | H | H | —CO— | Me | Propargyl | |
| 1-236 | Cl | Cl | Cl | H | H | —CO— | Me | Benzyl | |
| 1-237 | Cl | Cl | H | H | H | —CO— | Me | 3-Cl- | mp 112.3° C. |
| | | | | | | | | allyl | |
| 1-238 | Cl | Cl | H | H | H | —CO— | Me | 3-Phenyl- | Amorphous |
| | | | | | | | | propargyl | solid |
| 1-239 | Cl | Cl | H | H | H | —CH2— | Me | 3- | Oily |
| | | | | | | | | Pyridyl | substance |
| | | | | | | | | methyl | |
| 1-240 | Cl | Cl | H | H | H | —CO— | Me | 3- | Amorphous |
| | | | | | | | | Pyridyl | solid |
| | | | | | | | | methyl | |
| 1-241 | Cl | Cl | H | H | H | —CH2— | Propargyl | 3- | Amorphous |
| | | | | | | | | Pyridyl | solid |
| | | | | | | | | methyl | |
| 1-242 | Cl | Cl | H | H | H | —CH2— | H | 3- | Oily |
| | | | | | | | | Pyridyl | substance |
| | | | | | | | | methyl | |
| 1-243 | Cl | F | H | H | H | —CO— | Me | Propargyl | Oily |
| | | | | | | | | | substance |
| 1-244 | CF₃ | F | H | H | H | — | H | CHO | mp 94.9° C. |
| 1-245 | CF₃ | F | H | H | H | — | Me | Propargyl | Oily. |
| | | | | | | | | | substance |
| 1-246 | CF₃ | F | H | H | H | — | Me | 6-Cl-3- | Oily |
| | | | | | | | | pyridyl | substance |
| | | | | | | | | methyl | |
| 1-247 | CF₃ | F | H | H | H | — | H | CHO | mp 100.8° C. |
| 1-248 | Cl | H | H | O(5-CF₃- | H | — | H | CHO | mp 139.1° C. |
| | | | | 2- | | | | | |
| | | | | pyridyl) | | | | | |
| 1-249 | Cl | H | H | O(5-CF₃- | H | — | H | COMe | Amorphous |
| | | | | 2- | | | | | solid |
| | | | | pyridyl) | | | | | |
| 1-250 | Cl | H | H | O(5-CF₃- | H | — | H | H | Amorphous |
| | | | | 2- | | | | | solid |
| | | | | pyridyl) | | | | | |
| 1-251 | Cl | Cl | H | H | H | —CO— | Me | CH₂CF₃ | Amorphous |
| | | | | | | | | | solid |
| 1-252 | Cl | Cl | H | H | H | —CO— | H | CH₂CF₃ | mp 118.5° C. |
| 1-253 | Cl | Cl | H | H | H | —CO— | Me | CH₂CH₂Ome | Amorphous |
| | | | | | | | | | solid |
| 1-254 | Cl | Cl | H | H | H | —CO— | H | H | mp 108.8° C. |
| 1-255 | Cl | Cl | H | H | H | —CO— | H | 3-(1,2,4- | mp 175.6° C. |
| | | | | | | | | Triazolyl) | |
| 1-256 | Cl | Cl | H | H | H | —CO— | Me | 6-Cl-3- | Amorphous |
| | | | | | | | | pyridyl | solid |
| | | | | | | | | methyl | |
| 1-257 | Cl | Cl | H | H | H | —CO— | Me | 2-Furyl | Amorphous |
| | | | | | | | | | solid |
| 1-258 | Cl | Cl | H | H | H | —CO— | Me | 3-Cl- | Oily |
| | | | | | | | | benzyl | substance |
| 1-259 | Cl | Cl | H | H | H | —CO— | Me | Me | Oily |
| | | | | | | | | | substance |
| 1-260 | Cl | Cl | H | H | H | —CO— | Me | 4-Pyridyl- | Amorphous |
| | | | | | | | | methyl | solid |
| 1-261 | Cl | Cl | H | H | H | —CO— | Et | Benzyl | mp 111.9° C. |
| 1-262 | Cl | Cl | H | H | H | —CO— | Me | Phenethyl | Oily |
| | | | | | | | | | substance |
| 1-263 | Cl | Cl | H | H | H | —CO— | Me | 2-Cl- | Amorphous |
| | | | | | | | | benzyl | solid |
| 1-264 | Cl | Cl | H | H | H | —CO— | Me | 2-Pyridyl- | Amorphous |
| | | | | | | | | methyl | solid |
| 1-265 | CF₃ | Cl | F | H | H | —CO— | Me | Propargyl | Amorphous |
| | | | | | | | | | solid |
| 1-266 | CF₃ | Cl | F | H | H | —CO— | Et | Et | Oily |
| | | | | | | | | | substance |
| 1-267 | Cl | Cl | H | H | H | —CH2— | H | Et | |
| 1-268 | Cl | Cl | H | H | H | — | H | H | mp 102.0° C. |
| 1-269 | Cl | Cl | COMe | H | H | —CO— | H | Me | |
| 1-270 | Me | Me | Me | H | H | —CO— | H | Me | |
| 1-271 | Cl | H | CF₃ | Cl | H | —CO— | H | Me | mp 181.5° C. |
| 1-272 | CF₃ | H | Cl | H | Cl | —CO— | H | Me | |
| 1-273 | Cl | Cl | OCF₃ | H | H | —CO— | H | Me | |
| 1-274 | Cl | Cl | NHCHO | H | H | —CO— | H | Me | |
| 1-275 | Cl | Cl | NHSO₂CF₃ | H | H | —CO— | H | Me | |

TABLE 2

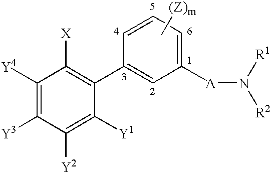

| | | | | | | | | | | Physical |
|---|---|---|---|---|---|---|---|---|---|---|
| No. | X | Y¹ | Y² | Y³ | Y⁴ | (Z)ₘ | A | R¹ | R² | property |
| 2-1 | Me | H | H | H | H | 4-Me | —CO— | Me | H | mp 92.3° C. |
| 2-2 | Me | H | H | H | H | 4-Me | —CO— | Me | Propargyl | Amorphous |
| | | | | | | | | | | solid |
| 2-3 | Me | Me | H | Me | H | 4-Me | —CO— | Me | H | mp 143.5° C. |
| 2-4 | Cl | H | H | H | H | 4-Me | —CO— | Me | H | |
| 2-5 | Cl | H | H | H | H | 4-Me | —CO— | Me | Allyl | |
| 2-6 | CF₃ | H | H | H | H | 4-Me | —CO— | Me | H | |
| 2-7 | OMe | H | H | H | H | 4-Me | —CO— | Me | H | |
| 2-8 | F | F | H | H | H | 4-Me | —CO— | Me | H | |
| 2-9 | OMe | H | Cl | H | H | 4-Me | —CO— | Me | H | |
| 2-10 | Me | Me | H | Me | H | 5-Me | —CO— | Me | H | |
| 2-11 | Me | Me | H | Me | H | 6-Me | —CO— | Me | H | |
| 2-12 | Me | Me | H | Me | H | 6-Cl | —CO— | Me | H | mp 130.0° C. |
| 2-13 | Me | Me | H | Me | H | 6-Cl | —CO— | Me | Propargyl | |
| 2-14 | Me | Me | H | Me | H | 6-Br | —CO— | Me | H | |
| 2-15 | Me | H | H | H | H | 4-Me | — | H | COMe | mp 130.7° C. |
| 2-16 | Cl | H | H | H | H | 4-Me | — | H | COMe | |
| 2-17 | CF₃ | H | H | H | H | 4-Me | — | H | COMe | |
| 2-18 | Me | H | H | H | H | 4-Me | — | H | H | mp 48.0° C. |
| 2-19 | Cl | H | H | Cl | H | 4-Me | —CO— | Me | H | mp 129.5° C. |
| 2-20 | Cl | H | H | Cl | H | 4-Me | —CO— | Me | Propargyl | |
| 2-21 | OMe | H | H | OMe | H | 4-Me | —CO— | Me | H | mp 155.3° C. |
| 2-22 | Cl | Cl | H | H | H | 6-F | —CO— | Me | H | mp 142.5° C. |
| 2-23 | Cl | Cl | H | H | H | 6-F | —CO— | Me | Propargyl | Amorphous |
| | | | | | | | | | | solid |
| 2-24 | Cl | Cl | Cl | H | H | 6-F | —CO— | Me | H | |

Now, Test Examples of the pesticides of the present invention will be described below. However, the present invention is by no means restricted thereto. In each test, the controlling index was determined on the basis of the following standards.

[Controlling Index]:[Degree of Disease Outbreak:Visual Observation]

5: No lesions nor sporogony recognizable

4: Area of lesions, number of lesions or area of sporogony is less than 10% of non-treated plot

3: Area of lesions, number of lesions or-area of sporogony is less than 40% of non-treated-plot

2: Area of lesions, number of lesions or area of sporogony is less than-70% of non-treated plot

1: Area of lesions, number of lesions or area of sporogony is at least 70% of non-treated plot

### Test Example 1

Tests on Preventive Effect Against Wheat Powdery Mildew

Wheat (cultivar: Norin-61-go) was cultivated in a polyethylene pot having a diameter of 7.5 cm, and when the wheat reached one and a half-leaf stage, the wheat was sprayed with 10 ml of a drug solution having a predetermined concentration of the compound of the present invention by a spray gun. After the drug solution dried, the wheat was inoculated by spreading with conidiospore of fungi of powdery mildew, and the wheat was kept in a thermostatic chamber at 20° C. From 6 to 7 days after the inoculation, the area of sporogony was examined to determine the controlling index in accordance with the above evaluation standards. As a result, among the above compounds, compounds Nos. 1-1, 1-2, 1-3, 1-4, 1-5, 1-6, 1-7, 1-9, 1-10, 1-11, 1-12, 1-13, 1-14, 1-15, 1-16, 1-17, 1-18, 1-19, 1-20, 1-21, 1-22, 1-23, 1-25, 1-27, 1-28, 1-29, 1-30, 1-31, 1-37, 1-41, 1-43, 1-44, 1-45, 1-46, 1-50, 1-58, 1-59, 1-60, 1-61; 1-64, 1-65, 1-66, 1-69, 1-70, 1-71, 1-72, 1-74, 1-75, 1-76, 1-77, 1-78, 1-79, 1-81, 1-82, 1-85, 1-86, 1-99, 1-100, 1-101, 1-105, 1-107, 1-112, 1-113, 1-123, 1-135, 1-137, 1-138, 1-139, 1-141, 1-142, 1-149, 1-150, 1-151, 1-152, 1-153, 1-154, 1-156, 1-157, 1-158, 1-159, 1-166, 1-169, 1-174, 1-175; 1-176, 1-177, 1-178, 1-179, 1-180, 1-181, 1-182, 1-183, 1-184, 1-185, 1-186, 1-187, 1-188, 1-189, 1-190, 1-191, 1-192, 1-193, 1-194, 1-195, 1-196, 1-198, 1-199, 1-200, 1-201, 1-202, 1-204, 1-205, 1-206, 1-207, 1-208, 1-209, 1-210, 1-211, 1-212, 1-213, 1-214, 1-215, 1-216, 1-217, 1-218, 1-220, 1-227, 1-228, 1-230, 1-234, 1-235, 1-236, 1-237, 1-238, 1-239, 1-240, 1-241, 1-242, 1-243, 1-244, 1-245, 1-246, 1-250, 1-251, 1-253, 1-254, 1-256, 1-257, 1-258, 1-259, 1-260, 1-261, 1-262, 1-263, 1-264, 1-265, 1-266, 1-267, 2-1, 2-2, 2-12, 2-19, 2-20, 2-22 and 2-23 showed effects with a controlling index of 4 or above at a concentration of 400 ppm. Compounds Nos. 1-67, 1-80, 1-88, 1-120, 1-124 and 2-18 showed effects with a controlling index of 4 or above at a concentration of 200 ppm. Compounds Nos. 1-83, 1-84, 1-89, 1-90, 1-91, 1-92, 1-93, 1-121, 1-122, 1-124, 1-126 and 1-127 showed effects with a controlling index of 4 or above at a concentration of 100 ppm.

### Test Example 2

Test on Preventive Effect Against Cucumber Powdery Mildew

Cucumber (cultivar: Sagamihanpaku) was cultivated in a polyethylene pot having a diameter of 7.5 cm, and when the cucumber reached one and a half-leaf stage, the cucumber was sprayed with a 10 ml of a drug solution having a predetermined concentration of the compound of the present invention by a spray gun. After the drug solution dried (the day of treatment or the next day), the cucumber was sprayed and inoculated with a conidiospore suspension of fungi of powdery mildew, and the cucumber was kept in a thermostatic chamber at 20° C. From 6 to 7 days after the inoculation, the area of spdrogony was examined to determine the controlling index in accordance with the above evaluation standards. As a result, among the above compounds, compounds-Nos. 1-1, 1-2, 1-4, 1-7, 1-10, 1-11, 1-13, 1-14, 1-17, 1-21, 1-29, 1-30, 1-31, 1-68, 1-71, 1-72, 1-74, 1-75, 1-76, 1-77, 1-79, 1-80, 1-81, 1-82, 1-86, 1-99, 1-100, 1-101, 1-109, 1-112, 1-113, 1-120, 1-123, 1-149, 1-150, 1-151, 1-152, 1-156, 1-159, 1-174, 1-175, 1-179, 1-180, 1-181, 1-182, 1-183, 1-184, 1-185, 1-188, 1-189, 1-192, 1-193, 1-194, 1-195, 1-207, 1-218, 1-228, 1-230, 1-231, 1-234, 1-235, 1-236, 1-237, 1-238, 1-242, 1-251, 1-253, 1-256, 1-259, 1-260, 1-266, 2-2, 2-22 and 2-23 showed effects with a controlling index of 4 or above at a concentration of 400 ppm. Compounds Nos. 1-88 and 1-186 showed effects with a controlling index of 4 or above at a concentration of 200 ppm.

Compounds Nos. 1-89, 1-90, 1-91, 1-93, 1-121, 1-122, 1-124 and 1-126 showed effects with a controlling index of 4 or above at a concentration of 100 ppm.

### Test Example 3

Test on Preventive Effect Against Cucumber Downy Mildew

Cucumber (cultivar: Sagamihanpaku) was cultivated in a polyethylene pot having a diameter of 7.5 cm, and when the cucumber reached two-leaf stage, the cucumber was sprayed with a 10 ml of a drug solution having a predetermined concentration of the compound of the present invention by a spray gun. After the drug solution dried (the day of treatment), the cucumber was sprayed and inoculated with a conidiospore suspension of fungi of downy mildew, and the cucumber was kept in a thermostatic chamber at 20° C. 7 Days after the inoculation, the area of sporogony was examined to determine the controlling index in accordance with the above evaluation standards. As a result, among the above compounds, compounds Nos. 1-27, 1-56, 1-198, 1-204 and 1-267 showed effects with a controlling index of 4 or above at a concentration of 400 ppm.

### Test Example 4

Test on Preventive Effect Against Rice Blast

Rice (cultivar: Nihonbare)-was cultivated in a polyethylene pot having a diameter of 7.5 cm, and when the rice reached one and a half-leaf stage, the rice was sprayed with 10 ml of a drug solution having a predetermined concentration of the compound of the present invention by a spray gun. After the drug solution dried, the rice was sprayed and inoculated with a conidiospore suspension of fungi of rice blast, and the rice was kept in an-inoculation box at 20° C. for 24 hours, and then kept in a thermostatic chamber at 20° C. From 6 to 11 days after the inoculation, the number of lesions was examined to determine the controlling index in accordance with the above evaluation standards. As a result, among the above compounds, compounds Nos. 1-43, 1-70, 1-77, 1-86, 1-164, 1-198, 1-204, 1-206, 1-208, 1-209, 1-216, 1-248, 1-250, 1-251, 1-252, 1-253 and 1-254 showed effects with a controlling index of 4 or above at a concentration of 400 ppm.

Now, Formulation Examples of the compounds of the present invention will be described below. However, the formulation dose, the dosage form or the like is by no means restricted to the following Examples.

### Formulation Example 1

| | | |
|---|---|---|
| (1) Compound of the present invention | 20 | parts by weight |
| (2) Clay | 72 | parts by weight |
| (3) Sodium lignin sulfonate | 8 | parts by weight |

The above components are uniformly mixed to obtain a wettable powder.

### Formulation Example 2

| | | |
|---|---|---|
| (1) Compound of the present invention | 5 | parts by weight |
| (2) Talc | 95 | parts by weight |

The above components are uniformly mixed to obtain a dust.

### Formulation Example 3

| | |
|---|---|
| (1) Compound of the present invention | 20 parts by weight |
| (2) N,N′-dimethylacetamide | 20 parts by weight |
| (3) Polyoxyethylene alkyl phenyl ether | 10 parts by weight |
| (4) Xylene | 50 parts by weight |

The above components are uniformly mixed and dissolved to obtain an emulsifiable concentrate.

### Formulation Example 4

| | | |
|---|---|---|
| (1) Clay | 68 | parts by weight |
| (2) Sodium lignin sulfonate | 2 | parts by weight |
| (3) Polyoxyethylene alkyl aryl sulfate | 5 | parts by weight |
| (4) Fine silica | 25 | parts by weight |

A mixture of the above components and the compound of the present invention are mixed in a weight ratio of 4:1 to obtain a wettable powder.

### Formulation Example 5

| | | | |
|---|---|---|---|
| (1) | Compound of the present invention | 50 | parts by weight |
| (2) | Oxylated polyalkylphenyl phosphate- | 2 | parts by weight |
| | triethanolamine | | |
| (3) | Silicone | 0.2 | part by weight |
| (4) | Water | 47.8 | parts by weight |

The above components are uniformly mixed and pulverized to obtain a stock solution, and

| | | |
|---|---|---|
| (5) Sodium polycarboxylate | 5 | parts by weight |
| (6) Anhydrous sodium sulfate | 42.8 | parts by weight |

are further added thereto, followed by uniform mixing, granulation and drying to obtain a granular wettable powder.

### Formulation Example 6

| | | |
|---|---|---|
| (1) Compound of the present invention | 5 | parts by weight |
| (2) Polyoxyethylene octylphenyl ether | 1 | part by weight |
| (3) Phosphate of polyoxyethylene | 0.1 | part by weight |
| (4) Particulate calcium carbonate | 93.9 | parts by weight |

The above components (1) to (3) are preliminarily mixed uniformly and diluted with a proper amount of acetone, the diluted mixture is sprayed on the component (4), and acetone is removed to obtain granules.

### Formulation Example 7

| | | |
|---|---|---|
| (1) Compound of the present invention | 2.5 | parts by weight |
| (2) N-methyl-2-pyrrolidone | 2.5 | parts by weight |
| (3) Soybean oil | 95.0 | parts by weight |

The, above components are uniformly mixed and dissolved to obtain an ultra low volume formulation.

### Formulation Example 8

| | | | |
|---|---|---|---|
| (1) | Compound of the present invention | 20 | parts by weight |
| (2) | Oxylated polyalkylphenol phosphate | 2 | parts by weight |
| | triethanolamine | | |
| (3) | Silicone | 0.2 | part by weight |
| (4) | Xanthan gum | 0.1 | part by weight |
| (5) | Ethylene glycol | 5 | parts by weight |
| (6) | Water | 72.7 | parts by weight |

The above components are uniformly mixed and pulverized to obtain an aqueous suspension.

### INDUSTRIAL APPLICABILITY

As described in the foregoing, the biphenyl derivative represented by the formula (I) or its salt has excellent effects as an active ingredient of a pesticide such as an agricultural or horticultural bactericide, or a fungicide.

1. A pesticide containing a biphenyl derivative represented by the formula (I) or its salt, as an active ingredient: 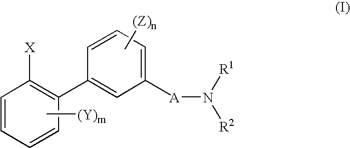
wherein, X and Y are each independently a halogen atom; a hydroxyl group; a formyl group; an alkyl group which may be substituted by halogen, alkoxy or alkylthio; a nitro group; an amino group which may be substituted by alkyl; an alkoxy group which may be substituted by halogen or alkoxy; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; an alkylsulfinyl group; or an imino group which may be substituted by alkyl or alkoxy,
Z is a halogen atom; a formyl group; an alkyl group which may be substituted by halogen; an alkoxy group which may be substituted by alkoxy; an alkylthio group; an alkylsulfonyl group; or an alkylsulfinyl group,
A is a carbonyl group; a thiocarbonyl group; an alkylene group; or a single bond,
R¹ and R² are each independently a hydrogen atom; an alkyl group which may be substituted by halogen, cycloalkyl, phenyl, substituted phenyl, heterocycle, substituted heterocycle, alkylthio, alkoxy or cyano; an alkenyl group which may be substituted by halogen, cycloalkyl, phenyl or cyano; an alkynyl group which may be substituted by halogen, cycloalkyl, phenyl or cyano; a cycloalkyl group which may be substituted by halogen or alkyl; an aryl group-which may be substituted by halogen, alkyl or haloalkyl; a heterocyclic group which may be substituted by halogen, alkyl or haloalkyl; an alkylcarbonyl group which may be substituted by halogen; an alkenylcarbonyl group; an imino group; an amino group which may be substituted by alkyl; an aminocarbonyl group which may be substituted by alkyl; an alkylcarbonylamino group; a formyl group; or a cyano group, and
m and n are each independently 0, 1, 2, 3 or 4.

2. An agricultural or horticultural bactericide containing the biphenyl derivative represented by the formula (I) or its salt as defined in claim 1, as an active ingredient.

3. A fungicide containing the biphenyl derivative represented by the formula (I) or its salt as defined in claim 1, as an active ingredient.

4. A biphenyl derivative represented by the formula (I) or its salt, as defined in claim 1, wherein X is a chloride atom; a bromine atom; an iodine atom; a hydroxyl group; a formyl group; an alkyl group which may be substituted by halogen, alkoxy or alkylthio; a nitro group; an amino group which may be substituted by alkyl; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonylamino group; an alkylcarbonyl group which may be substituted by halogen; an alkylthio group; an alkylsulfonyl group; or an aIkylsulfinyl group,
Y is a halogen atom; a hydroxyl group; a formyl group; an alkyl group which may be substituted by halogen, alkoxy or alkylthio; a nitro group; an amino group which may be substituted by alkyl; an aryloxy group which may be substituted by halogen or haloalkyl; a heterocyclic oxy group which may be substituted by halogen or haloalkyl; a heterocyclic group which may be substituted by halogen or haloalkyl; an aminocarbonyl group which may be substituted by alkyl; an alkylcarbonyl amino group; an alkylcarbonyl group which may be substituted by halogen; an alkylthio group; an alkylsulfonyl group; or an alkylsulfinyl group,
Z is a halogen atom; a formyl group; or an alkyl group which may be substituted by halogen,
A is a carbonyl group; a thiocarbonyl group; or single bond, and
m and n are each independently 0, 1, 2, 3 or 4.

5. The biphenyl derivative and its salt according to claim 4, wherein m is 2, one Y is substituted at the para position to X and the other Y is substituted at the ortho position to the bonding position of the two phenyl rings.

6. A method for controlling a plant disease, which comprises applying the biphenyl derivative represented by the formula (I) or its salt as defined in claim 1 to an agricultural or horticultural plant.
